(19) United States
(12) Patent Application Publication
(10) Pub. No.: US 2024/0323826 A1
(43) Pub. Date: Sep. 26, 2024

(54) FIRST NODE, SECOND NODE, THIRD NODE, COMMUNICATIONS SYSTEM AND METHODS PERFORMED THEREBY FOR HANDLING ROAMING OF A WIRELESS DEVICE FROM A FIRST COMMUNICATIONS NETWORK

(71) Applicant: Telefonaktiebolaget LM Ericsson (publ), Stockholm (SE)

(72) Inventors: Athanasios KARAPANTELAKIS, SOLNA (SE); Konstantinos VANDIKAS, SOLNA (SE); Maxim TESLENKO, SOLLENTUNA (SE); Lackis ELEFTHERIADIS, Valbo (SE); Aneta VULGARAKIS FELJAN, STOCKHOLM (SE); Xiajing LI, Stockholm (SE); Gabriella NORDQUIST, STOCKHOLM (SE); Marin ORLIC, BROMMA (SE); Alexandros NIKOU, Danderyd (SE); Marios DAOUTIS, Bromma (SE)

(73) Assignee: Telefonaktiebolaget LM Ericsson (publ), Stockholm (SE)

(21) Appl. No.: 18/579,228

(22) PCT Filed: Jul. 15, 2021
(86) PCT No.: PCT/EP2021/069831

§ 371 Date: Jan. 12, 2024

(51) Int. Cl. H04W 48/18; H04W 24/08

(52) U.S. Cl. CPC H04W 48/18; H04W 24/08

(57) ABSTRACT

A method performed by a first node (111). The method is for handling roaming of a wireless device (130) from a first communications network (101). The first node (111) operates in a communications system (100). The first node (111) determines (502) a second communications network (201) to be used by the wireless device (130) for roaming communications. The determining (502) is based at least on: a) a predicted energy supply by the wireless device (130) during a roaming period, and b) a predicted use of data by the wireless device (130) during the roaming period. The first node (111) provides (504) an indication of the determined second communications network (201) to at least one of: a second node (112) operating in the communications system (100) and the wireless device (130).

### TECHNICAL FIELD

The present disclosure relates generally to a first node and methods performed thereby for handling roaming of a wireless device from a first communications network. The present disclosure relates generally to a second node and methods performed thereby for handling roaming data. The present disclosure relates generally to a third node and methods performed thereby for handling roaming of the wireless device from the first communications network. The present disclosure relates generally to a communications system and methods performed thereby for handling roaming of the wireless device from the first communications network.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-UTRA, as well as a Fifth Generation (5G) Packet Core Network, which may be referred to as 5G Core Network, abbreviated as 5GC.

A 3GPP system comprising a 5G RAN, a 5G Core Network and a User Equipment (UE) may be referred to as a 5G system.

Roaming may be understood as defined by a collection of specifications that may allow a wireless device, e.g., a third-generation partnership project (3GPP) mobile device, such as a mobile phone, in 3GPP terms, which may be known as UE, to use available radio access services of an operator other than the operator it may be subscribed to, which may also be known as home operator. The operator providing these services may be known as a visiting operator. FIG. 1 is a schematic diagram depicting two alternative types of roaming. Note that the figure and the description that follows illustrate Long Term Evolution (LTE) of Fourth Generation (4G) network nodes and refer to LTE Standards, but similar approaches may be understood to exist for 5G networks. The top diagram depicts Home-Routed Roaming 1, as Alternative A, and the bottom diagram depicts Local-Breakout Roaming 2 as Alternative B. The interconnection 3 between the visiting network 4 and the home network 5, may be either managed by a third party, e.g., an Internet Protocol exchange (IPX)/General Packet Radio Service (GPRS) Roaming exchange (GRX) network vendor, or operators may establish direct connections between them, managing them themselves. In general, there may be three pieces of data that any visiting network 4 may need to retrieve from the home network 5 in order for the former network to provide a radio access service to a UE 6 subscribed to the latter. First, data regarding the mobile subscription and specifically authentication information that may include the unique International Mobile Subscription Identity (IMSI) of the UE 6, as well as a private key that may be used for authenticating the UE 6, as per the initial attach process described in [1]. Other optional information, depending on what services the operator may have enabled may include a subscriber service profile, indicating which services the UE 6 may be allowed to use, such as Presence and Location, Service Initiation Information, etc. Second, a visiting network may need to retrieve data regarding the Quality of Service (QOS) policies applied to the UE 6 data traffic, “user-plane” 7, on the uplink/downlink interface, via establishment of Evolved Packet Switched system (EPS) bearers, in 5G, these may be known as QoS flows. This may be understood to be important so the visiting operator may replicate the QoS policies configured for the UE 6 and stored in the home network 5 to the visiting network 4. Third, a visiting network 4 may need to retrieve, billing information, not illustrated in FIG. 1 as billing may have different configurations.

FIG. 2 and FIG. 3 are schematic diagrams illustrating three different types of billing configurations. FIG. 2 illustrates the first and second billing configurations. FIG. 3 illustrates the third billing configuration. The first billing configuration, Alternative A 24, comprises billing at the visiting network 25, and no revenue at the home network 26. In the second billing configuration, Alternative B 25, the most common alternative, the visiting network 25 may exchange billing information with the home network 26 directly. Billing may take place at the home network 26, and the revenue may be shared. In the third billing configuration, Alternative C 28, billing may be settled by a third-party interconnection vendor, or another third party. The billing at the third party may take place via the interconnection 29 between the visiting network 25 and the home network 26, which may be a GRX/IPX network or a direct connection. Alternative C 28 may be understood to not be possible if the connection is direct. The revenue may then be shared. A Billing Center 30 may be located in the home network 26 in alternative B 27 and Alternative C 28, and in the visiting network 25 in each of the alternatives, wherein billing information may be obtained from a PGW 31. may comprise. In Alternative C, another billing center 30 may be located in the GRX/IPX network.

Looking at FIG. 1, in alternative A 1, the user data traffic 7, illustrated using thick arrows with straight arrowheads, may be routed from the visiting network 4 to the home network 5 and via the packet gateway (PGW) 8 to its ultimate destination. Subscription information stored in the home subscriber server (HSS) 7 may be transmitted from the visiting network 4 to the home network 5. In alternative B 2, the user data traffic 7 may be routed from the visiting network 4 directly to its ultimate destination, thus lowering latency. This type of roaming may be known as “local breakout”. In addition to subscription information, in this case, the home network 5 may transmit policy information to the visiting network 4. Also depicted in FIG. 1 are the UE control/user plane traffic 9, and control plane traffic 10. The traffic may go through an eNB 11, a Signalling Gateway (SGW) 12, a Mobility Management Entity (MME) 13, Policy and Charging Rules Function (PCRF) 14. Also depicted are the interfaces between the different entities: Uu 15, S1u 16, S8 17, Gx 18, S1-MME 19, S6a 20, SGi 21, and S9 22. Lastly FIG. 1 also depicts Internet or voice messaging services 23.

In the home routing mechanism, the roaming subscriber user plane data plane 7 information may be routed back to the Home Public Land Mobile Network (HPLMN), which may be controlled and administered by the home operator. This mechanism may come with the drawback of considerable latency and Service Level Agreement (SLA) issues.

In the Local breakout (LBO) mechanism, the visited operator may be understood to have the control and mechanism of the roaming subscribers signalling. LBO may be used for latency purposes, since user-plane data traffic may not need to be routed from the visiting network to the home network, and from there to the destination. Instead, it may get routed directly from the visited network to the destination.

Current roaming methods may be understood to be based on pre-existing business agreements between the operators, and as such, devices will roam by default to a preset operator when in certain geographical area, e.g., in another country. This comes at a cost of energy resources for the devices.

### SUMMARY

As part of the development of embodiments herein, one or more challenges with the existing technology with regards to roaming will first be identified and discussed.

First, roaming may only take place across 3GPP networks, although these 3GPP networks may not necessarily be of the same radio access technology (RAT). Inter-standard roaming may allow for example roaming between Code-division multiple access (CDMA) networks and Time Division Multiple Access (TDMA), such as Global System for Mobile Communications (GSM). Note that for certain cases, it may also be possible for a mobile subscriber of a cellular network to use Wi-Fi cellular services whenever possible, for example, by means of handover from the latter to the former, as described in [2]. However, this may be understood to not be roaming, as it may be performed within the administrative domain of a single mobile network operator. Roaming, on the other hand, may be understood to require exchange of considerably more data than mobility information, for example, QoS policies, mobile subscription data, charging data, etc. Another feature commonly used may be Wireless Fidelity (WiFi) calling or Voice over WiFi (VoWiFi), which may use the Generic Access Network (GAN) protocol to be able to receive and make calls using WiFi in areas of poor cell coverage. However, this may be understood to not be roaming either, as QoS, billing and authentication policies may not carry over from cellular to WiFi.

Another issue with roaming may be that the selection of the network to roam to may typically be performed either by initiative of the user, by selecting their preferred network from the networks their home operator may have agreements with, or when users may be out of coverage of their home network. Since different RATs may have different characteristics that may benefit different types of UEs at different points in time, having a user select their preferred network to roam to may prevent achieving those benefits. For example, [3] has shown that the average energy consumption of WiFi may be lower than that of LTE in different scenarios. However, in WiFi, mobility of devices may be restricted, even though roaming may be supported, see IEEE 802.11r-2008. The predominant deployments of WiFi may be “hotspots”, that is, independent access points at specifics points of interest. WiFi may also be faster than LTE, but slower than 5G, see https://www.opensignal.com/2020/05/06/5g-download-speed-is-now-faster-than-wifi-in-seven-leading-5g-countries. According to this, devices low on power and not particularly mobile, may obtain a higher benefit from using WiFi networks, whereas devices with a high degree of mobility and high on power may obtain a higher benefit from using 5G networks.

In view of the foregoing, it is an object of embodiments herein to improve the handling roaming of a wireless device from a first communications network. It is a particular object of embodiments herein to improve the handling of roaming by providing a method for automated roaming of UE between heterogeneous RATs.

According to a first aspect of embodiments herein, the object is achieved by a method, performed by a first node. The method may be understood to be for handling roaming of a wireless device from a first communications network. The first node operates in a communications system. The first node determines a second communications network to be used by the wireless device for roaming communications. The determining is based at least on: a) a predicted energy supply by the wireless device during a roaming period, and b) a predicted use of data by the wireless device during the roaming period. The first node also provides an indication of the determined second communications network to at least one of: a second node operating in the communications system and the wireless device.

According to a second aspect of embodiments herein, the object is achieved by a method, performed by the third node. The method may be understood to be for handling roaming of the wireless device from the first communications network. The third node operates in one of the communications system. The third node determines, using machine learning: a) a first predictive model of energy supply by the wireless device during the roaming period, and b) a second predictive model of use of data by the wireless device during the roaming period. The third node also provides to the first node operating in the communications system a first indication. The first indication indicates the energy supply by the wireless device during the roaming period, as predicted with the first predictive model. The third node also provides a second indication indicating the use of data by the wireless device during the roaming period as predicted with the second predictive model.

According to a third aspect of embodiments herein, the object is achieved by a method, performed by the second node. The method may be understood to be for handling roaming data. The second node operates in the communications system. The second node obtains, from the first node operating in the communications system the indication. The indication is of the second communications network determined to be used by the wireless device for roaming communications during the roaming period. The second node also updates a database with the obtained indication. The database is a distributed, level database comprising a plurality of layers. The plurality of layers comprises a first layer comprising first data of operators of respective communications networks. The first data comprises respective one or more Radio Access Technologies (RATs), used by the respective operators. The first data comprises a respective coverage map of the respective operators. The plurality of layers also comprises a second layer linked to the first layer. The second layer comprises second data of respective roaming agreements of the operators with the first communications network the wireless device is roaming from. The plurality of layers also comprises a third layer linked to the second layer. The third layer comprises roaming transactions of wireless devices in any of the respective communications networks. The wireless devices comprise the wireless device.

According to a fourth aspect of embodiments herein, the object is achieved by a method, performed by the communications system comprising the first node, the third node and the second node, according to the method performed by the first node, the method performed by the second node and the method performed by the third node.

According to a fifth aspect of embodiments herein, the object is achieved by the first node. The first node may be considered to be for handling roaming of the wireless device from the first communications network. The first node is further configured to determine the second communications network to be used by the wireless device for roaming communications. The determining is configured to be based at least on: a) the predicted energy supply by the wireless device during the roaming period, and b) the predicted use of data by the wireless device during the roaming period. The first node is further configured to provide the indication of the second communications network configured to be determined to at least one of: the second node configured to operate in the communications system and the wireless device.

According to a sixth aspect of embodiments herein, the object is achieved by the third node. The third node may be considered to be for handling roaming of the wireless device from the first communications network. The third node is further configured to operate in the communications system. The third node is further configured to determine, using machine learning: a) the first predictive model of energy supply by the wireless device during the roaming period, and b) the second predictive model of use of data by the wireless device during the roaming period. The third node is also configured to provide to the first node configured to operate in the communications system the first indication configured to indicate the energy supply by the wireless device during the roaming period, as configured to be predicted with the first predictive model. The third node is also configured to provide to the first node the second indication configured to indicate the use of data by the wireless device during the roaming period as configured to be predicted with the second predictive model.

According to a seventh aspect of embodiments herein, the object is achieved by the second node. The second node may be understood to be for handling roaming data. The second node is configured to operate in one of the communications system. The second node is further configured to obtain, from the first node configured to operate in the communications system the indication. The indication is configured to be of the second communications network configured to be determined to be used by the wireless device for roaming communications during the roaming period. The second node is further configured to update the database with the indication configured to be obtained. The database is configured to be a distributed, level database comprising a plurality of layers. The plurality of layers is configured to comprise the first layer configured to comprise the first data of operators of respective communications networks. The first data is configured to comprise the respective one or more RATs configured to be used by the respective operators. The first data is configured to comprise the respective coverage map of the respective operators. The plurality of layers is also configured to comprise the second layer. The second layer is configured to be linked to the first layer. The second layer is configured to comprise the second data of respective roaming agreements of the operators with the first communications network the wireless device is configured to be roaming from. The plurality of layers is further configured to comprise the third layer configured to be linked to the second layer. The third layer is configured to comprise the roaming transactions of wireless devices in any of the respective communications networks. The wireless devices are configured to comprise the wireless device.

According to an eighth aspect of embodiments herein, the object is achieved by a the communications system configured to comprise the first node, the second node and the third node.

By determining the second communications network to be used by the wireless device for roaming communications, based on the predicted energy supply and the predicted use of data by the wireless device during the roaming period, the first node may be enabled to select the second communications network in an optimized way, for the data traffic profile and battery life of the wireless device during roaming. Hence, the first node may enable that the resources provided to the wireless device may be used efficiently, avoiding to waste resources, while at the same time, enabling to maintain current QoS policies the wireless device may have.

As a further advantage, this may be achieved without a need to change the standards, hence simplifying the implementation process.

By providing the indication to the second node, the first node may enable the second node to maintain the database with information that may be reused for future determinations of the most optimal communications network for roaming of the wireless device or other wireless devices.

By providing the indication to the wireless device, the first node may enable the wireless device to roam using the most optimal communications network for roaming, in terms of efficient usage of its resources. Hence, for example, its battery life may be preserved for a longer period of time.

By determining, the first predictive model and the second predictive model, the third node may be enabled to accurately predict the behavior of the wireless device during the future roaming period, in terms of energy supply and use of data. The third node may then be enabled to provide the predicted energy supply, and predicted use of data of the wireless device during the roaming period to the first node. By providing this information to the first node, the third node may thereby enable the first node to optimize the selection of the second communications network to be used by the wireless device during roaming, based on the predicted behavior of the wireless device.

By obtaining the indication, the second node may be enabled to update the database.

By updating the database with the indication in this Action, the second node may be enabled to enrich the database and thereby enable to optimize selection of other second communication networks for the wireless device or other wireless devices, in other roaming periods.

### BRIEF DESCRIPTION OF THE DRAWINGS

Examples of embodiments herein are described in more detail with reference to the accompanying drawings, and according to the following description.

FIG. 1 is a schematic diagram illustrating an example of roaming alternatives in a 4G network, according to existing methods.

FIG. 2 is a schematic diagram illustrating an example of billing alternatives, according to existing methods.

FIG. 3 is a schematic diagram illustrating an example of another billing alternative, according to existing methods.

FIG. 4 is a schematic diagram illustrating a communications system, according to embodiments herein.

FIG. 5 depicts a flowchart of a method in a first node, according to embodiments herein.

FIG. 6 depicts a flowchart of a method in a third node, according to embodiments herein

FIG. 7 depicts a flowchart of a method in a second node, according to embodiments herein

FIG. 8 is a schematic diagram illustrating an example of a distributed ledger exemplary instance, according to embodiments herein.

FIG. 9 is a schematic diagram illustrating an example of components of a communications system, according to embodiments herein.

FIG. 10 is a schematic diagram illustrating some aspects of methods in a communications networks, according to embodiments herein.

FIG. 11 is a schematic diagram illustrating some aspects of methods in a communications networks, according to embodiments herein.

FIG. 12 is a signalling diagram illustrating a non-limiting example of methods in a communications networks, according to embodiments herein.

FIG. 13 is a schematic diagram illustrating some aspects of methods in a communications networks, according to embodiments herein.

FIG. 14 is a schematic diagram illustrating some aspects of methods in a communications networks, according to embodiments herein.

FIG. 15 is a schematic block diagram illustrating two non-limiting examples, a) and b), of a first node, according to embodiments herein.

FIG. 16 is a schematic block diagram illustrating two non-limiting examples, a) and b), of a second node, according to embodiments herein.

FIG. 17 is a schematic block diagram illustrating two non-limiting examples, a) and b), of a third node, according to embodiments herein.

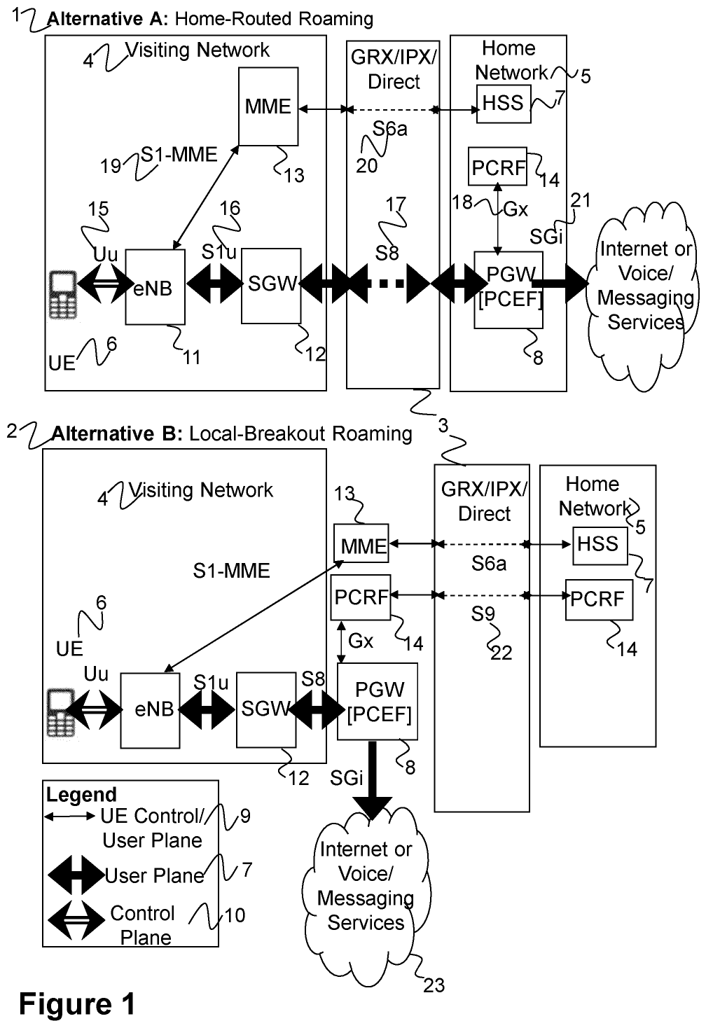

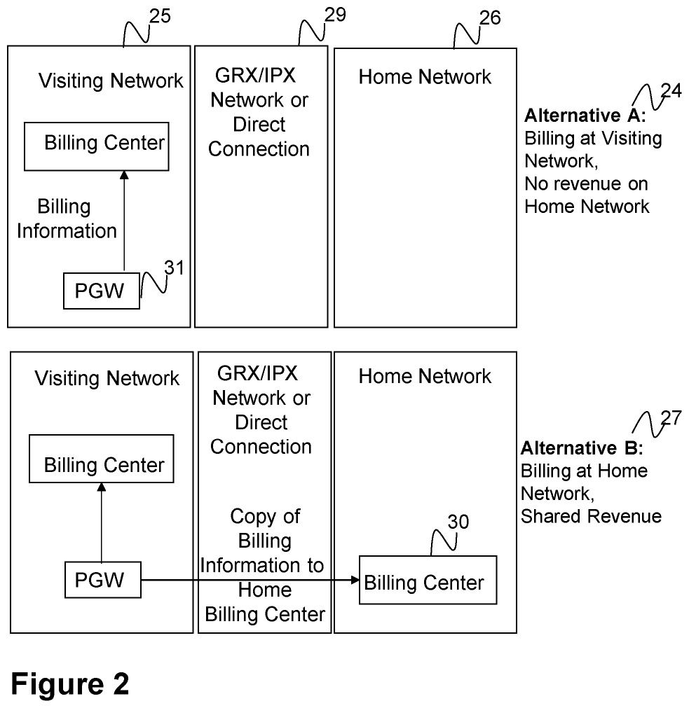

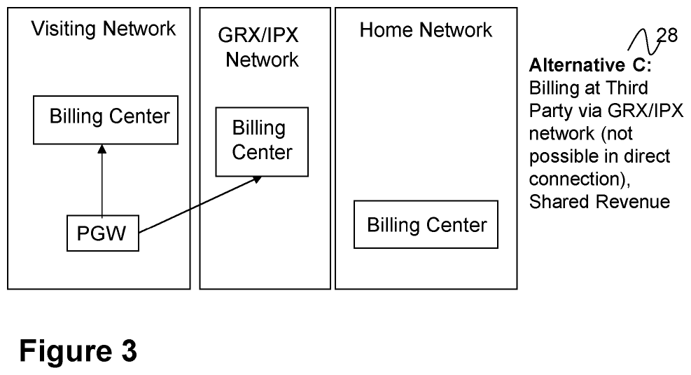

### DETAILED DESCRIPTION

Certain aspects of the present disclosure and their embodiments may provide solutions to the challenges discussed in the Summary section or other challenges. There are, proposed herein, various embodiments which address one or more of the issues disclosed herein.

As a brief overview, embodiments herein may be understood to relate to a machine learning approach to choosing a visiting operator during roaming of a wireless device. The selection process may be based on a distributed ledger. Particular embodiments herein may be understood to relate to a machine learning approach to inter-RAT roaming.

As a general overview, embodiments herein may be understood to relate to an alternative approach to roaming, wherein a control element referred to herein as a “radio access broker” may decide which network to use for roaming, based on characteristics of the wireless device such as the traffic, mobility and power profile of the device. One part of embodiments herein may be based on a distributed ledger, accessible to both operators and wireless devices. The ledger may store mobile operator information, such as coverage, type of RAT and roaming agreements with other operators. Using machine learning and based on a prediction of the mobility pattern and battery usage of the wireless device, based on predicted data traffic generated from and/or received by the UE, the control element may choose one of the visiting operators the home operator of the wireless device may have roaming agreements with, as the operator to attach to for the foreseeable future.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

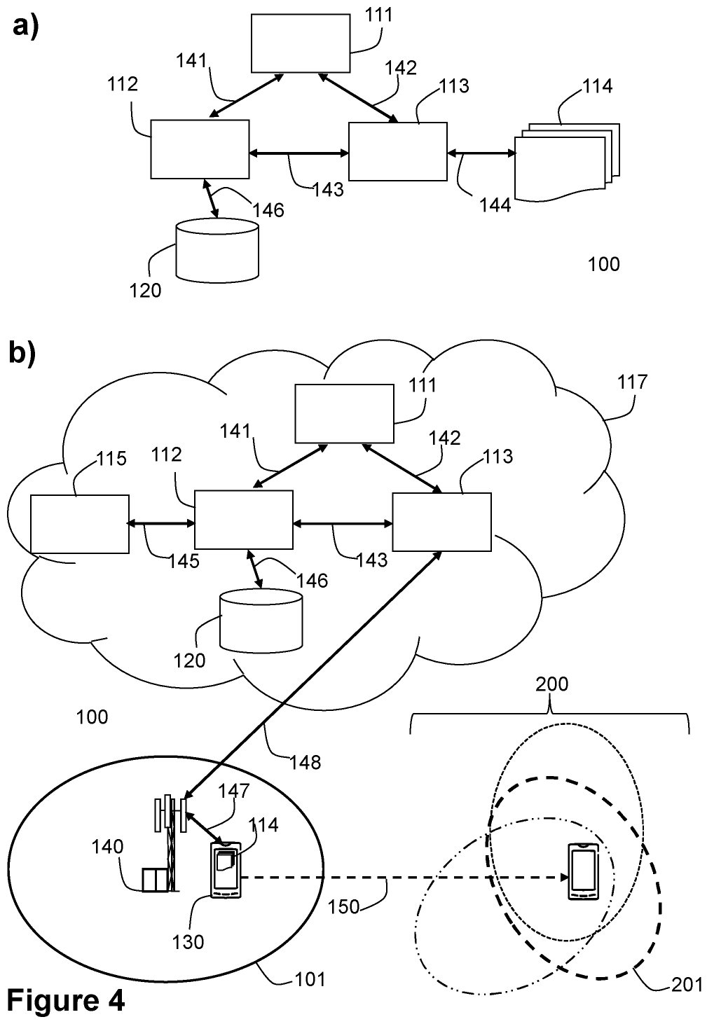

FIG. 4 depicts two non-limiting examples, in panel a) and panel b), respectively, of a communications system 100, in which embodiments herein may be implemented. The communications system 100 comprises a first communications network 101 and may comprise a plurality of other communications networks 200. The plurality of other communications networks comprises a second communications network 201. The plurality of communications networks 200 may comprise one or more additional communications networks. In the non-limiting examples of FIG. 4, the plurality of communications networks 200 comprises the second communications network 201 and two additional communications networks, each schematically represented by an oval with different patterns of dashed lines. However, it may be understood that the plurality of other communications networks 200 may comprise more or fewer communications networks, and that the number depicted in FIG. 4 is non-limiting. The plurality of other communication networks 200 may be operated by one or more operators. The one or more operators may be understood as radio access vendors, cellular or non-cellular, providing radio access services to devices, such as the wireless device 130 described below. Each of the communication networks in the plurality of other communications networks 200 may be operated by a respective operator. Two or more of the other communication networks in the plurality of other communication networks 200 may have a same operator. The first communications network 101 may also have its respective operator, e.g., a first operator. The first operator may be different than the one or more operators of the plurality of other communication networks 200.

Any of the first communications network 101 and the communications networks comprised in the plurality of other communications networks 200 may be sometimes also referred to as a radio system, network or wireless communications system. Any of the first communications network 101 and the communications networks comprised in the plurality of other communications networks 200 may be a cellular radio system or cellular network. Any of the first communications network 101 and the communications networks comprised in the plurality of other communications networks 200 may for example be a network such as 5G system, or Next Generation network, or a newer system supporting similar functionality. In some examples, any of the first communications network 101 and the communications networks comprised in the plurality of other communications networks 200 may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), UTRA TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of RATs such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as 6LowPAN, Bluetooth, or any cellular network or system.

In particular examples of embodiments herein, the first communications network 101 and the second communications networks 201 may operate on different RATs. That is, the first communications network 101 may operate on a first RAT, e.g., 5G, and the second communications network 201 may operate on a second RAT, e.g., WiFi.

The first communications network 101 may be understood to be a home network and the second communications network 201 may be understood to be a visited network. In some particular examples, the first communications network 101 may be an HPLMN and the second communications network 201 may be a VPLMN.

The communications system 100 may comprise a plurality of nodes, whereof a first node 111, a second node 112, a third node 113 and one or more fourth nodes 114 are depicted in FIG. 4. In some embodiments, such as that depicted in the non-limiting example of panel b) in FIG. 4, the communications system 100 may comprise a fifth node 115. When referring to any of the nodes, a different node may be referred to another node. In particular embodiments, any of the third node 113 and the fifth node 115 may be referred to as the another node 113, 115. The communications system 100 may be understood to comprise, in other examples not depicted in FIG. 4, one or more additional nodes.

Any of the first node 111, the second node 112, the third node 113, the one or more fourth nodes 114, the fifth node 115 and the another node 113, 115 operate in the communications system 100. In some non-limiting examples, any of the first node 111, the second node 112, the third node 113, the one or more fourth nodes 114, the fifth node 115 and the another node 113, 115 may operate in the first communications network 101. Any of the first node 111, the second node 112, the third node 113, the one or more fourth nodes 114, the fifth node 115 and the another node 113, 115 may be understood, respectively, as a first computer system, a second computer system, a third computer system, one or more fourth computer systems, a fifth computer system and another computer system. In some examples, any of the first node 111, the second node 112, the third node 113, the one or more fourth nodes 114, the fifth node 115 and the another node 113, 115 may be implemented as a standalone server in e.g., a host computer in the cloud 117. Any of the first node 111, the second node 112, the third node 113, the one or more fourth nodes 114, the fifth node 115 and the another node 113, 115 may in some examples be a distributed node or distributed server, with some of their respective functions being implemented locally, e.g., by a client manager, and some of its functions implemented in the cloud, by e.g., a server manager. Yet in other examples, any of the first node 111, the second node 112, the third node 113, the one or more fourth nodes 114, the fifth node 115 and the another node 113, 115 may also be implemented as processing resources in a server farm.

Any of the first node 111, the second node 112, the third node 113, the one or more fourth nodes 114, the fifth node 115 and the another node 113, 115 may be co-located, or be the same node. In other examples, however, any of the first node 111, the second node 112, the third node 113, the one or more fourth nodes 114, the fifth node 115 and the another node 113, 115 may be different nodes. All the possible combinations are not depicted in FIG. 4 to simplify FIG. 4.

Any of the first node 111, the second node 112, the third node 113, the one or more fourth nodes 114, the fifth node 115 and the another node 113, 115 may be comprised in the wireless device 130 described below. In particular examples such as that depicted in panel b) of FIG. 4, the one or more fourth nodes 114 may be comprised in the wireless device 130. In other examples, the first node 111, the third node 113, and the one or more fourth nodes 114 may be comprised in the wireless device 130. In other examples, any of the first node 111, the second node 112 and the third node 113 may be comprised in the cloud 117. Any of the first node 111, the second node 112, the third node 113 and the another node 113, 115, may be a core network node, of a core network.

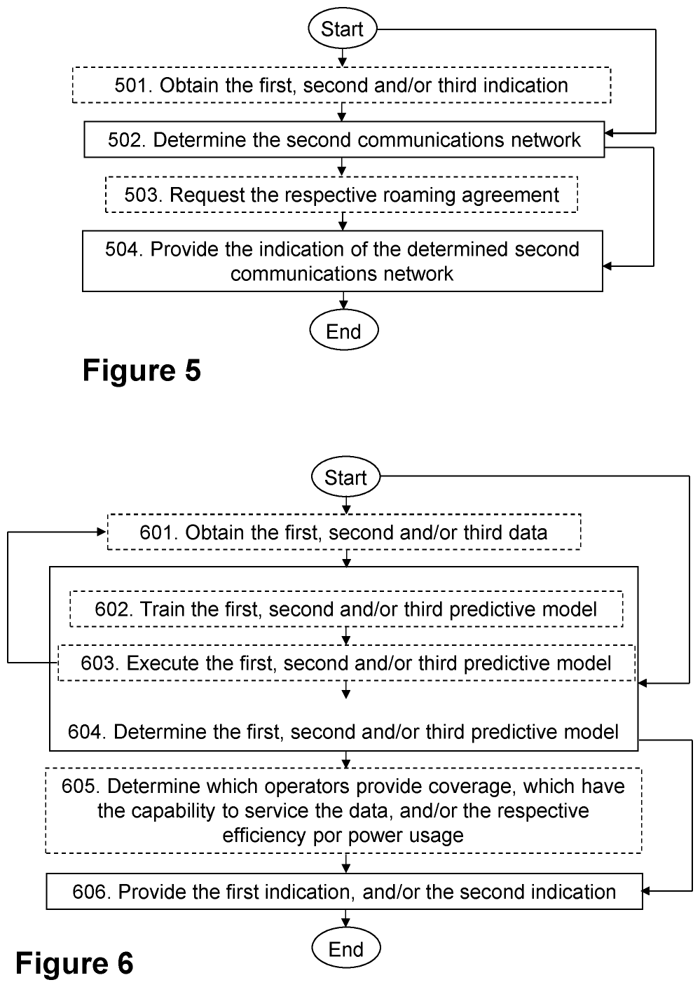

In some examples of embodiments herein, the first node 111 may be referred to herein as a radio access broker, given the functionality described for this node, e.g., in relation to FIG. 5. The first node 111 may have a capability to suggest the best radio access service for a device such as the wireless device 130 described below, depending on its requirements, capabilities and location. While FIG. 4 illustrates this entity as a standalone entity, in a preferred example, it may be comprised within the wireless device 130, but may also be a third-party service.

The second node 112 may have a capability to manage a database 120. To manage may be understood to herein as to provide an interface that may enable to write to and to read from the data in the database 120. The database 120 may be at least one of: i) layered and ii) immutable and synchronized. The database 129 may be a distributed ledger, e.g., a distributed ledger as a blockchain. However, other forms of distributed ledger may also be used, for example a distributed, multi-layered hash table. In particular examples, the database 120 may be a multi-layer distributed ledger, an immutable, replicable, consensus-based database which may comprise connectivity information, roaming agreements and billing information for radio access services rendered to mobile devices from the participating radio access vendors. The database 120 will be described with further detail in relation to FIG. 6.

In some examples of embodiments herein, the third node 113 may manage one or more neural networks.

In some examples, the one or more fourth nodes 114 may be the one or more fourth nodes 114 may be comprised in the wireless device 130 and may comprise: Network Interface Card (NIC) Application Program Interface, API, a battery subsystem and a UE positioning system.

In some examples of embodiments herein, the another node 113, 115 may be one of: i) a third node 113 managing one or more neural networks, and ii) a node operating in one of the plurality of communication networks 200.

The first communications network 101 may comprise one or more devices, of which a wireless device 130 is represented in FIG. 4. The wireless device 130 may be also known as e.g., a UE, mobile terminal, wireless terminal and/or mobile station, mobile telephone, cellular telephone, or laptop with wireless capability, or a Customer Premises Equipment (CPE), just to mention some further examples. The wireless device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, or any other radio network unit capable of communicating over a link in the first communications network 101 and/or the second communications network 201. The wireless device 130 may be wireless, i.e., it may be enabled to communicate wirelessly in the first communications network 101 or in the second communications network 201 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the first communications network 101 and the second communications network 201.

The communications system 100 may comprise a plurality of radio network nodes, such as a radio network node 140, which is depicted in the non-limiting example of panel b) in FIG. 4. Any of the radio network nodes may typically be a base station or Transmission Point (TP), or any other network unit capable to serve a wireless device or a machine type node in the first communications network 101, and second communications network 201, respectively. Any of the radio network nodes may be e.g., a 3G Node B (NB), a 4G eNB, a 5G gNB. The radio network node 140 may be e.g., a Wide Area Base Station, Medium Range Base Station, Local Area Base Station and Home Base Station, based on transmission power and thereby also coverage size. Any of the radio network nodes may be e.g., a gNB, a 4G eNB, or a 5G or alternative 5G radio access technology node, e.g., fixed or WiFi. Any of the radio network nodes may be a stationary relay node or a mobile relay node. Any of the radio network nodes may support one or several communication technologies, and its name may depend on the technology and terminology used. Any of the radio network nodes may be directly connected to one or more networks and/or one or more core networks.

Any of the radio network nodes may cover a geographical area which may be divided into cell areas, wherein each cell area may be served by a radio network node, although, one radio network node may serve one or several cells.

The first node 111 may communicate with the second node 112 over a first link 141, e.g., a radio link or a wired link. The first node 111 may communicate with the third node 113 over a second link 142, e.g., a radio link or a wired link. The second node 112 may communicate with the third node 113 over a third link 143, e.g., a radio link or a wired link. The third node 113 may communicate with the one or more fourth nodes 114 over a respective fourth link 144, e.g., a radio link or a wired link. The second node 112 may communicate with the fifth node 115 over a fifth link 145, e.g., a radio link or a wired link. The second node 112 may communicate with the database 120 over a sixth link 146, e.g., a radio link or a wired link. The one or more fourth nodes 114 may communicate with the radio network node 140 over a respective seventh link 147, e.g., a radio link or a wired link. The radio network node 140 may communicate with the wireless device 130 over an eighth link 148, e.g., a radio link or a wired link. The dashed arrow indicates the roaming 150 direction of the wireless device 130 out of the coverage of the first communications network 101, that is, from the first communications network 101.

Any of the links described in the previous paragraph, may be a direct link or comprise one or more links, e.g., via one or more other network nodes, or radio network nodes, or, with the exception of the respective seventh link 147 and the eighth link 148, core network nodes. Any of the described in the previous paragraph, with the exception of the respective seventh link 147 and the eighth link 148, may be a direct link or it may go via one or more computer systems or one or more core networks, e.g., in the first communications network 101, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 4.

In general, the usage of “first”, “second”, “third”, “fourth”, “fifth”, “sixth”, “seventh” and/or “eighth” herein may be understood to be an arbitrary way to denote different elements or entities, and may be understood to not confer a cumulative or chronological character to the nouns they modify.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

Although terminology from Long Term Evolution (LTE)/5G has been used in this disclosure to exemplify the embodiments herein, this should not be seen as limiting the scope of the embodiments herein to only the aforementioned system. Other wireless systems, support similar or equivalent functionality may also benefit from exploiting the ideas covered within this disclosure. In future radio access, e.g., in the sixth generation (6G), the terms used herein may need to be reinterpreted in view of possible terminology changes in future radio access technologies.

Embodiments of a method, performed by the first node 111, will now be described with reference to the flowchart depicted in FIG. 5. The method may be understood to be for handling roaming of the wireless device 130 from the first communications network 101. The first node 111 operates in the communications system 100.

Several embodiments are comprised herein. In some embodiments all the actions may be performed. In other embodiments, two or more actions may be performed. One or more embodiments may be combined, where applicable. All possible combinations are not described to simplify the description. It should be noted that the examples herein are not mutually exclusive. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 5. In FIG. 5, actions which may be optional in some examples are depicted with dashed boxes.

### Action 501

In the course of operations of the communications network 100, the wireless device 130 may roam, from its home network, the first communications network 101, to a visited network, the second communications network 201.

The first node 111 may be understood as a radio access broker which may select which of the other communications networks in the plurality of other communications networks 200 the wireless device 130 may roam into. In order for the first node 111 to eventually perform such a selection, in this Action 501, the first node 111 may obtain, from the third node 113 operating in the communications system 100, at least one of the following options. According to a first option, the first node 111 may obtain a first indication indicating a predicted energy supply by the wireless device 130 during a roaming period. The energy supply may be, for example, a level of battery of the wireless device 130. The energy supply may be understood to be predicted, since the third node 113, as will be explained later, may use machine learning techniques to, predict, at a certain time or time period, which may be the expected energy supply the wireless device 130 may be expected to have, based on past energy supply level trends. For example, the first indication may be a set of probabilities of battery level at the end of the next day being [<20%, 20%-40%, 41%-70%, >71%], being for the wireless device 130, e.g., [2%, 18%, 78%, 5%].

According to a second option, the first node 111 may obtain a second indication indicating a predicted use of data by the wireless device 130 during the roaming period. The use of data may be, e.g., Downlink (DL) and/or Uplink (UP) throughput, and it may be understood to be predicted, since the third node 113, as will be explained later, may use machine learning techniques to, predict, at a certain time or time period, which may be the data use the wireless device 130 may be expected to have, based on past data use trends. For example, the second indication may be a set of probabilities of average aggregate traffic for the next day being [<2 Mbps, 2-4 Mbps, 4-6 Mbps, >8 Mbps], being for the wireless device 130, e.g., [4%, 25%, 50%, 7%].

According to a third option, the first node 111 may obtain a third indication indicating a predicted future location of the wireless device 130 during the roaming period. The location, e.g., the geographical location of the cell the wireless device 130 may be attached to, may be understood to be predicted, since the third node 113, as will be explained later, may use machine learning techniques to, predict, at a certain time or time period, which may be the future location the wireless device 130 may be expected to have, based on past mobility trends. For example, the third indication may be a set of probabilities of radius of movement in km from a current position of the wireless device 130 for a day being [<1 km, 1-3.99 km, 4 km-8 km, >8 km]. The current position may be, for example, the location of the cell the wireless device 130 may be currently attached to, or the last known location of the wireless device 130, being for the wireless device 130, e.g., [5%, 43%, 95%, 3%].

Obtaining may be understood as receiving or acquiring, e.g., via the second link 142.

According to a first group “A” of embodiments herein, as will be explained later, the first node 111 may choose a roaming operator for the wireless device 130 based on the existing roaming agreements, whereas in a second group “B” of embodiments herein, as will be explained later, the first node 111 may choose a roaming agreement from all available operators, creating if necessary, a roaming agreement dynamically. These two groups of embodiments will be described in detail later. In order for the first node 111 to be able to perform any of these two groups of embodiments, in some embodiments, the obtaining in this Action 501 may further comprise obtaining a list of available operators wherein the list may comprise at least one of: a) all available operators at the predicted future location of the wireless device 130 during the roaming period, and b) a subset of the available operators the first operator of the first communications network 101 may have a roaming agreement with.

In some examples of embodiments herein, the first node 111 may choose the other communications network for the wireless device 130 to roam into taking into consideration cost. Accordingly, the obtaining in this Action 501 may further comprise obtaining respective billing information from the available operators.

By obtaining the first indication, the second indication, and the third indication in this Action 501, the first node 111 may then be enabled to determine the second communications network 201 to be used by the wireless device 130 for roaming communications in the next Action 502, optimizing the roaming selection for the mobility of the wireless device 130 based on data traffic profile and battery life of the wireless device 130.

### Action 502

In this Action 502, the first node 111 determines a second communications network 201 to be used by the wireless device 130 for roaming communications. The determining in this Action 502 is based at least on: a) the predicted energy supply by the wireless device 130 during a roaming period, e.g., as indicated by the first indication, and b) the predicted use of data by the wireless device 130 during the roaming period, e.g., as indicated by the second indication.

Determining may be understood as calculating, choosing, selecting, etc. . . .

In some embodiments, the determining in this Action 502 may be further based on: c) the predicted future location of the wireless device 130 during the roaming period, e.g., as indicated by the third indication.

In some embodiments, the determining in this Action 502 may comprise determining at least one of: i) which operators may be available and provide coverage to the predicted future location of the wireless device 130 during the roaming period, ii) which of the available operators providing coverage may have a capability to service the predicted use of data by the wireless device 130 during the roaming period, and iii) a respective efficiency of power usage of respective RAT, used by the available operators providing coverage.

In other words, in this Action 502, the first node 111 may use a selection algorithm which may select among a set of operators, the most suitable one for the wireless device 130. For that purpose, the first node 111 may take into account the type of RAT a visiting operator may provide, the coverage and the amount of traffic. First, the first node 111 may filter down operators to those that may provide coverage based on the predicted future location, that is, the predicted mobility pattern, of the wireless device 130. Second, an operator from the filtered list of operators may be chosen, based on whether it may cover the average predicted use of data, e.g., the throughput values, but also depending on the predicted energy supply, e.g., the level of battery, if, for example, battery may be predicted to be less than 20%, then an operator providing a higher power-efficient RAT but with lower throughput may be preferred. In general, different bias and/or tradeoffs may be considered between serving throughput and conserving power.

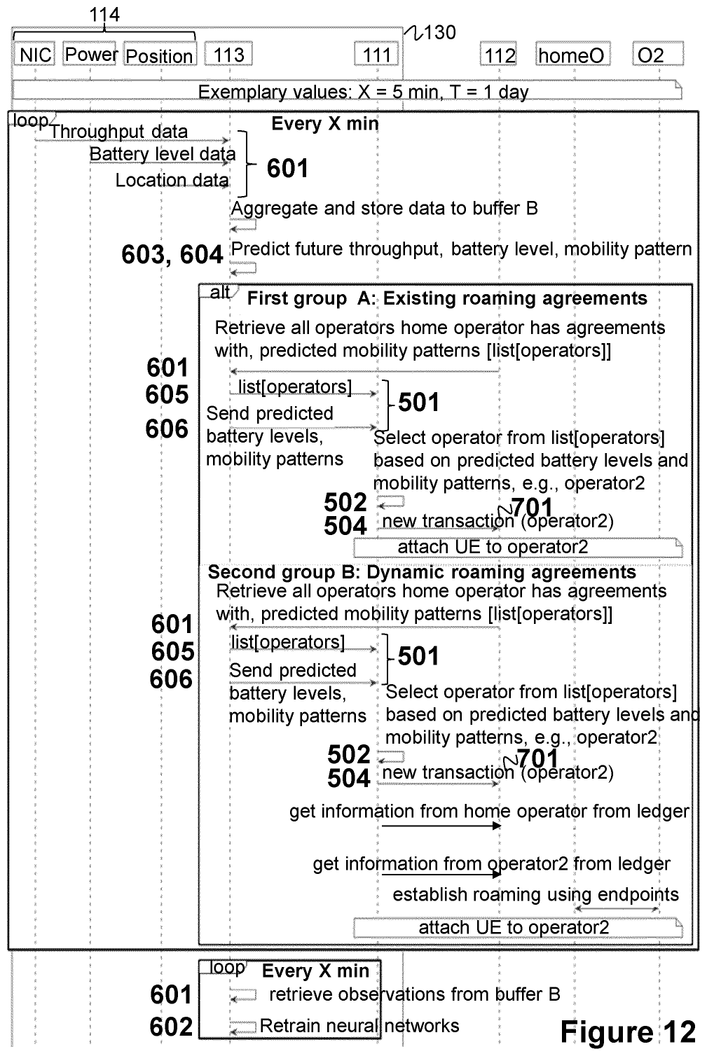

As mentioned earlier, two different groups of embodiments are disclosed, one where the first node 111 may choose a visiting operator from preset roaming agreements, and one where a roaming agreement may be formed dynamically. These cases will be illustrated in the sequence diagram of FIG. 12.

In some embodiments, the determining in this Action 502 may be further based on the obtained respective billing information from the available operators. For such embodiments, first, the first node 111 may filter down the operators to those that may provide coverage based on the predicted mobility pattern of the wireless device 130. Second, an operator from the filtered list of operators may be chosen, based on whether it may cover the average predicted throughput values, but also depending on the level of battery. If, for example, battery is predicted to be less than 20%, then an operator providing a higher power-efficient RAT but with lower throughput may be preferred. In general, different bias and/or tradeoffs may be considered between serving throughput and conserving power.

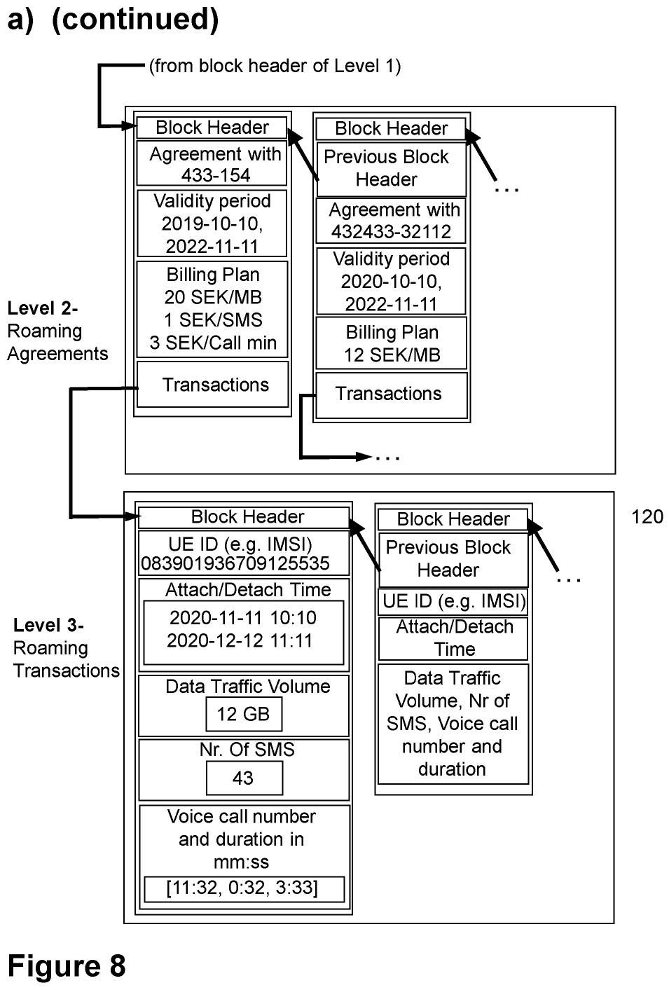

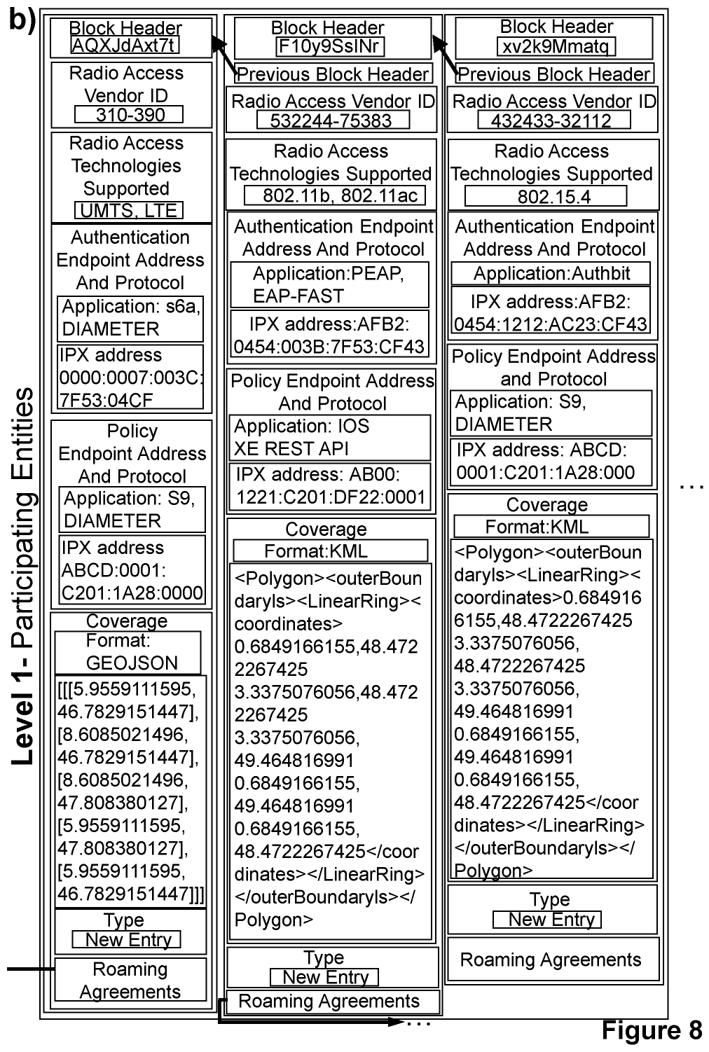

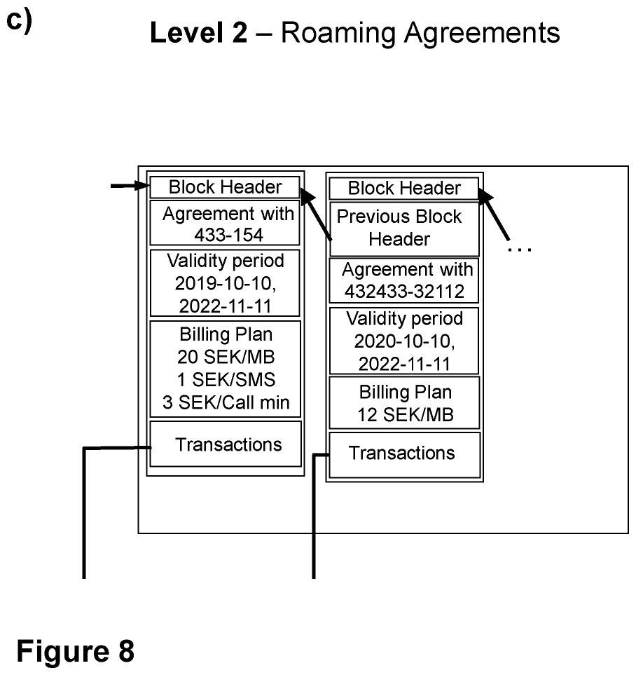

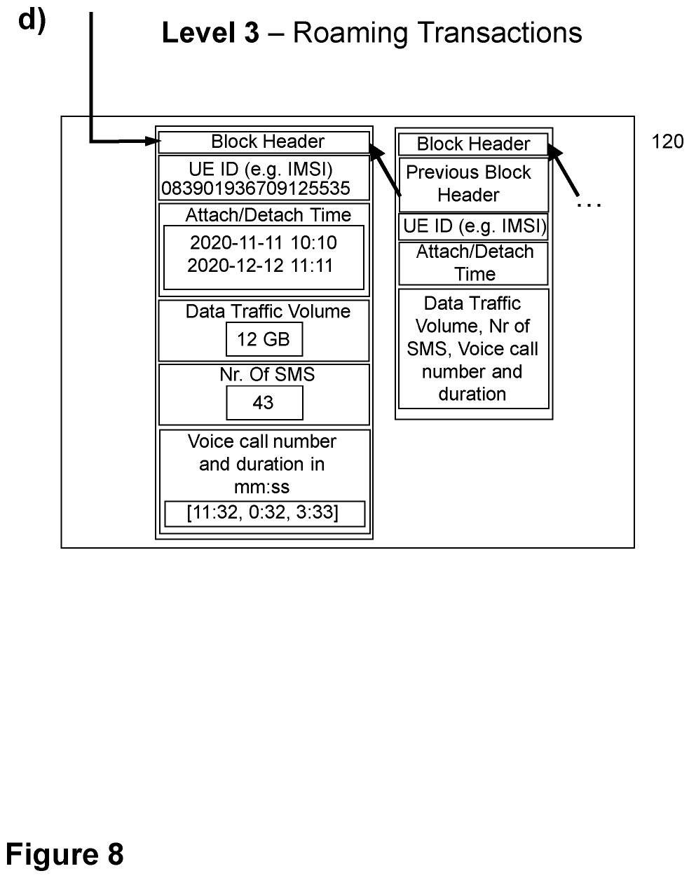

In some examples, in addition to throughput values and RAT power efficiency, charging may be taken into account. That is, billing may be used as an objective factor by the first node 111 in the roaming partner selection algorithm run in this Action 502. As mentioned earlier, two different groups of embodiments are disclosed. In the first group “A” of embodiments, the first node 111 may choose a roaming operator from existing roaming agreements. In these embodiments, billing plans of existing roaming agreements, e.g., in the blocks in layer 2 of the database 120 which will be described later in relation to FIG. 8, may be taken into account, and the roaming agreement that may have the smallest price may gain an advantage. This “advantage” may be understood to mean that the decision may be weighed based on price, RAT energy efficiency and throughput requirements from the wireless device 130. In the second group “B” of embodiments, the first node 111 may choose a roaming agreement from all available operators, creating, if necessary, a roaming agreement dynamically.

By, in this Action 502, determining the second communications network 201 to be used by the wireless device 130 for roaming communications, based on the predicted energy supply and the predicted use of data by the wireless device 130 during the roaming period, the first node 111 may be enabled to select the second communications network 201 in an optimized way, for the data traffic profile and battery life of the wireless device 130. The selection may be further optimized by the mobility of the wireless device 130. Hence, the first node 111 may enable that the resources to the wireless device 130 may be used efficiently, avoiding to waste resources, while at the same time, enabling to maintain current QoS policies the wireless device 130 may have.

As a further advantage, this may be achieved without a need to change the standards, hence simplifying the implementation process.

### Action 503

In agreement with the second group “B” of embodiments, in some embodiments, the determined second communications network 201 may lack a current roaming agreement with the first communications network 101. In some of these embodiments, in this Action 503, the first node 111 may request a respective roaming agreement from the determined second communications network 201 to provide roaming services to the wireless device 130 during the roaming period.

In these embodiments, the policy endpoint may be used by the first node 111 for operators that may not have roaming agreements with the home operator of the wireless device 130. Operators may offer a price for roaming, and based on the logic of the first group “A” of embodiments, a roaming agreement may be established. As a side note, the price may then affect all subsequent wireless devices which may roam to this operator from the current home operator. For reasons of fairness, each operator may be asked once, without knowledge of an “offer” from another operator.

By requesting a respective roaming agreement in this Action 503, the first node 111 may be able to dynamically create a previously non-existent agreement with the second communications network 201, so that if the first node 111 has determined this is the network that may be most optimal for the wireless device 130 for the roaming, the agreement may be established on the fly to be able to provide service to the wireless device 130. Thereby, usage of another communications network which may not be optimal for the wireless device 130 in terms of usage of resources, may be avoided.

### Action 504

In this Action 504, the first node 111 provides an indication of the determined second communications network 201 to at least one of: the second node 112 operating in the communications system 100 and the wireless device 130.

The provided indication may be a fourth indication. The fourth indication may be, for example, an entry to record a transaction in the database 120, in a roaming agreement transactions layer of the database 120, as will be described later.

The providing, e.g., sending or transmitting, may be performed, e.g., via the first link 141, to the second node 112, and via another link, not depicted in FIG. 4, to the wireless device 130.

By providing the indication to the second node 112 in this Action 504, the first node 111 may enable the second node 112 to maintain the database 120 with information that may be reused for future determinations of the most optimal communications network for roaming.

By providing the indication to the wireless device 130 in this Action 504, the first node 111 may enable the wireless device 130 to roam using the most optimal communications network for roaming, in terms of efficient usage of its resources. Hence, for example, its battery life may be preserved for a longer period of time.

In some examples, the wireless device 130 may be provisioned in the second communications network 201 with, e.g., certificates for encrypted communication which may need to be created, the wireless device 130 may be added in the database 120, etc. . . . This may usually take time. In some examples, this provisioning may be performed ahead of time. In the case of failure, or too long delay, in the provisioning process, the wireless device 130 may fallback to another operator even though that may not be the optimal choice, to avoid breaking connectivity.

Embodiments of a method, performed by the third node 113, will now be described with reference to the flowchart depicted in FIG. 6. The method may be understood to be for handling roaming of the wireless device 130 from the first communications network 101.

The third node 113 operates in the communications system 100.

Several embodiments are comprised herein. In some embodiments all the actions may be performed. In other embodiments, two or more actions may be performed. One or more embodiments may be combined, where applicable. All possible combinations are not described to simplify the description. It should be noted that the examples herein are not mutually exclusive. Components from one embodiment may be tacitly assumed to be present in another embodiment and it will be obvious to a person skilled in the art how those components may be used in the other exemplary embodiments. A non-limiting example of the method performed by the third node 113 is depicted in FIG. 6. In FIG. 6, actions which may be optional in some examples are depicted with dashed boxes. The detailed description of some of the following corresponds to the same references provided above, in relation to the actions described for the first node 111 and will thus not be repeated here to simplify the description. For example, the energy supply may be, for example, a level of battery of the wireless device 130.

### Action 601

In this Action 601, the third node 113 may obtain, from one or more fourth nodes 114 operating in the communications system 100, at least one of the following data options. According to a first option, a) first data indicating energy supply by the wireless device 130 during earlier roaming. According to a second option, b) second data indicating use of data by the wireless device 130 during the earlier roaming. According to a third option, c) third data indicating a future location of the wireless device 130 during the earlier roaming period.

The obtaining, e.g., receiving or acquiring in this Action 601 may be implemented e.g., via the respective fourth link 144.

The one or more fourth nodes 114, as stated earlier may be, e.g., different subsystems of the wireless device 130, such as throughput from a Network Interface Card (NIC), battery from the power subsystem and location from a positioning subsystem. Such information may be typically accessible through use of Application Program Interfaces (APIs) provided by the vendor of the operating system the wireless device 130 may be running, e.g., iOS or Android. This data may be aggregated on a timescale, e.g., per minute, stored in a buffer of the third node 113. The received data may be a time series of historical and current information.

The obtaining in this Action 601 may further comprise obtaining a list of available operators. The list may comprise at least one of: a) all available operators at the predicted future location of the wireless device 130 during the roaming period, and b) a subset of the available operators a first operator of the first communications network 101 has a respective roaming agreement with.

By providing the first, second and third data in this Action 601, the third node 113 may be enabled to train, execute, and ultimately determine, using machine learning, different predictive models of energy supply, use of data and mobility of the by the wireless device 130 during the roaming period. Later, the third node 113 may use such predictive models to determine the behavior of the wireless device 130 during the future roaming period in terms of energy supply and use of data. The third node 113 may then be enabled to provide the predicted energy supply, and predicted use of data of the wireless device 130 during the roaming period, and thereby enable the first node 111 to optimize the selection of the second communications network 201 to be used by the wireless device 130 during roaming, based on the predicted behavior of the wireless device 130.

Similarly the third node 113 may use such predictive models to accurately predict the location of the wireless device 130 during the future roaming period. The third node 113 may then be enabled to provide the predicted location of the wireless device 130 during the roaming period, and thereby enable the first node 111 to optimize the selection of the second communications network 201 to be used by the wireless device 130 during roaming, based on the predicted location of the wireless device 130.

### Action 602

The third node 113, which may be understood as a prediction element, may comprise three neural networks, preferably, although not exclusively, Recurrent Neural Networks (RNNs), such as Long Short-Term Memory (LSTM) networks, since the nature of the input data may be understood to be a time series of historical and current information.

One neural network, that is, a first neural network, may predict the future battery reserves of the wireless device 130 based on current and historical throughput data, as well as current and historical battery levels. Accordingly, in this Action 602, the third node 113 may train a first predictive model with a first set of the obtained first data. The first set may be understood to refer to the fact that not all the obtained first data may be used for the training in this Action 602.

Another neural network, that is, a second neural network, may predict future use of data based on current and historical throughput generated and/or received from the wireless device 130, e.g., both uplink and downlink data traffic. Accordingly, in this Action 602, the third node 113 may train a second predictive model with a first set of the obtained second data.

Finally, a third neural of the neural networks, that is, a third neural network, may predict the future location of the wireless device 130, based on current and previous locations. Accordingly, in this Action 602, the third node 113 may train a third predictive model with a first set of the obtained third data.

According to the foregoing, in this Action 602, the third node 113 may train at least one of: the first predictive model, the second predictive model, and the third predictive model. Training of these neural networks in this Action 602 may happen periodically, with data retrieved by the one or more fourth nodes 114, and optionally stored in the buffer of the third node 113, and the neural networks may be incrementally trained every day. Predictions may be made using data from the last minutes, input as time series to the Long Short-Term Memory (LSTMs).

Action 602 may be considered a training phase of a machine learning process.

By training the different predictive models of energy supply, use of data and mobility of the by the wireless device 130 during the roaming period, the third node 113 may be enabled to increase the predictive accuracy of these models, and later use such predictive models to determine the behavior of the wireless device 130 during the future roaming period in terms of energy supply and use of data. The third node 113 may then be enabled to provide the predicted energy supply, and predicted use of data of the wireless device 130 during the roaming period, and thereby enable the first node 111 to optimize the selection of the second communications network 201 to be used by the wireless device 130 during roaming, based on the predicted behavior of the wireless device 130.

Similarly, by training the third predictive model, the third node 113 may be enabled to accurately predict the location of the wireless device 130 during the future roaming period. The third node 113 may then be enabled to provide the predicted location of the wireless device 130 during the roaming period, and thereby enable the first node 111 to optimize the selection of the second communications network 201 to be used by the wireless device 130 during roaming, based on the predicted location of the wireless device 130.

### Action 603

In this Action 603, the third node 113 may execute 603 at least one of: the first predictive model with a second set of the obtained first data, the second predictive model with a second set of the obtained second data, and the third predictive model with a second set of the obtained third data.

To execute may be understood herein as to run or to test the predictive model, which may take place with a certain periodicity, e.g., every X minutes, for example, every 5 minutes, daily.

Action 603 may be considered a testing phase of the machine learning process.

### Action 604

In this Action 604, the third node 113 determines, using machine learning: a) the first predictive model of energy supply by the wireless device 130 during the roaming period, and b) the second predictive model of use of data by the wireless device 130 during the roaming period. The determining of the first predictive model may be based on the obtained first data. The determining of the second predictive model may be based on the obtained second data.

In some embodiments, the determining in this Action 604 may further comprise determining: a) the third predictive model of a future location of the wireless device 130 during the roaming period. The determining of the third predictive model may be based on the obtained third data.

The determining of the first predictive model may be further based on additionally obtained first data, e.g., fresh first data. The determining of the second predictive model may be based on additionally obtained second data, e.g., fresh second data. The determining of the third predictive model may be based on additionally obtained third data, e.g., fresh third data.

The determining in this Action 604 may be understood as the obtention of a final predictive model to be used to provide predictions on the behavior of the wireless device 310 to the first node 111 for the determination of the second communications network 201. The determining in this Action 604 may comprise one or more iterations Action 602 and Action 603, for every iteration of Action 601, for example, until a desired level of accuracy of the respective models may be obtained.

In some embodiments, the determining in this Action 604 may be based on one or more iterations of the training in Action 602 and the executing in Action 603.

Table 1 below illustrates a non-limiting example of the input from the one or more fourth nodes 114, and output for the three neural networks of the third node 113. It may be noted that the predictions illustrated may last for a day, but different timescales may be considered.

TABLE 1
LSTM: Prediction of future data

| | Output Data - probability of average |
|---|---|
| Input Data | aggregate traffic for next day |
| [avg_{throughput}_{_{—}}ᵤₚₗᵢₙₖ, | [<2 Mbps, 2-4 Mbps, |
| avg_{throughput}_{_{—}}_{downlink}, time] | 4-6 Mbps, >8 Mbps] |
| 2.43, 3.42, 10:10 | [4%, 25%, 50%, 7%] |
| 2.33, 4.32, 10:15 | |
| 2.12, 4.31, 10:20 | |
| 2.1, 5.4, 10:25 | |

LSTM: Prediction of future battery levels

| | Output Data - probability of battery level at |
|---|---|
| Input Data [avg_{throughput}_{_{—}}ᵤₚₗᵢₙₖ, | the end of next day |
| avg_{throughput}_{_{—}}_{downlink}, batteryₗₑᵥₑₗ, time] | [<20%, 20%-40%, 41%-70%, >71%] |
| 2.43, 3.42, 50%, 10:10 | [2%, 18%, 78%, 5%] |
| 2.33, 4.32, 48%, 10:15 | |
| 2.12, 4.31, 45%, 10:20 | |
| 2.1, 5.4, 42%, 10:25 | |

LSTM: Prediction of mobility patterns

| | Output Data - Radius of movement in km |
|---|---|
| | from current position for a day [<1 km, |
| | 1-3.99 km, 4 km-8 km, >8 km] (current position |
| Input Data | can be for example the location of the cell |
| [centroid_{latitude}, centroid_{longitude}, | the UE is currently attached to, or the last |
| radius, time] | known location of the UE) |
| [38.8951, −77.0364, 1.32 km, 10:10] | [5%, 43%, 95%, 3%] |
| [38.9951, −77.2364, 0.12 km, 10:15] | |
| [38.9951, −77.1364, 0.22 km, 10:20] | |

The third node 113, which may be understood as a predictor component, may be a part of the wireless device 130, as e.g., illustrated later in FIG. 12, although it may be placed outside of the wireless device 130. In preferred examples, the location may be nearby the wireless device 130, e.g., in an edge cloud that may be close or part of the RAN.

The advantage for having the third node 113 outside of the wireless device 130 may be understood to be to save battery life, as executing and training the neural network may be computationally expensive, and may therefore drain battery life much faster when compared to having these tasks carried out by a component that may run on a cloud infrastructure powered by the local power grid. Another advantage to consider may be that the third node 113 may need to access the list of operators, or agreements, within the predicted mobility patterns, potentially exposing the trade secrets of the operators. A disadvantage with having the third node 113 outside of the wireless device 130 may be understood to be the latency of communication. However, latency effects may be mitigated if the cloud infrastructure may reside close to the wireless device 130, and propagation over the radio network may be sub-millisecond, e.g., as it may be in 5G NR.

### Use of Secure Aggregation for Increasing Accuracy of the Predictive Models

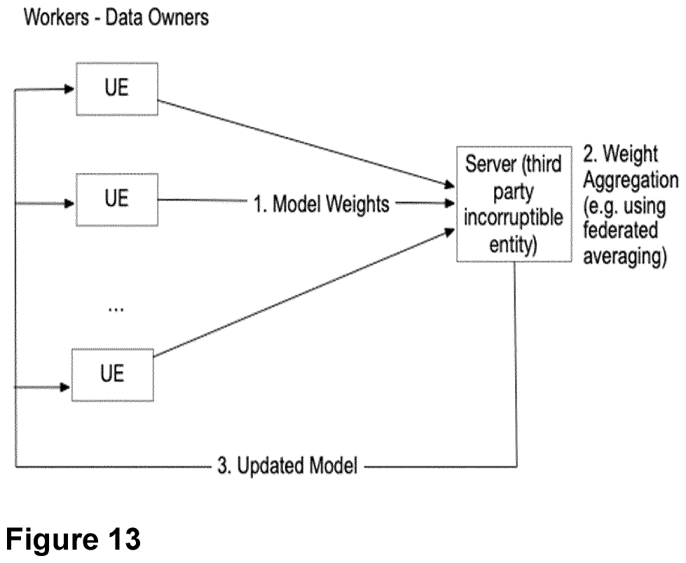

Federated learning and secure aggregation may be used to increase a respective accuracy of the predictive models. In this scenario, every wireless device, e.g., as the wireless device 130, may be a worker and there may exist a centralized server that may perform a secure aggregation, as will be discussed in relation to FIG. 13.

The third node 113 in such examples may be server a third-party incorruptible node. Hence, the third node 113 may not belong to a specific operator, but a third-party authority. Alternatively, a GPRS Roaming Exchange/Internetwork Packet Exchange (GRX/IPX) network owner, trusted by all participating operators may also provide the service.

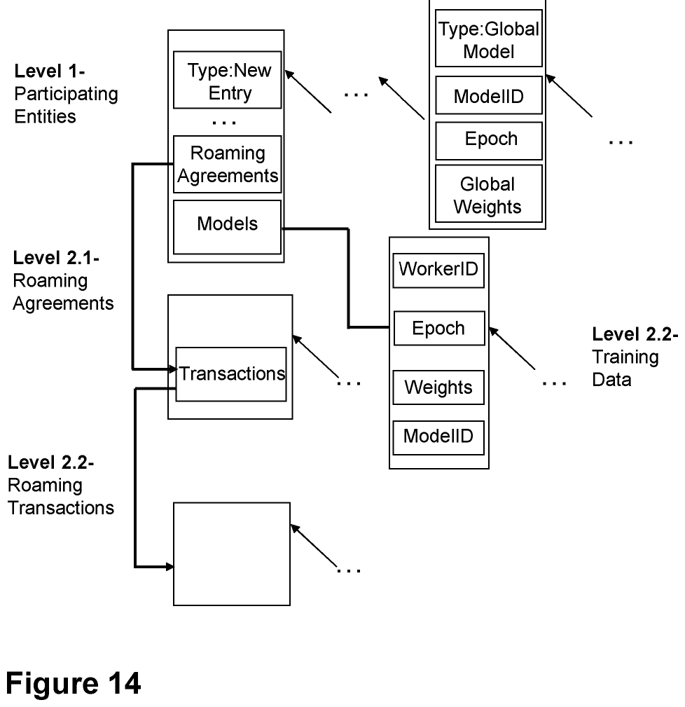

The communication for this approach may still rely on the database, e.g., a distributed ledger. Specifically, there may be new sublayers from layer 1, which may contain the weights of each neural network, as a result of training individually on every worker. A global model may be also stored in the database 120 and may be fetched by the workers in each training iteration, see also FIG. 14.

This approach may be understood to have the additional advantage that workers with bad and/or erroneous data may be identified and left out from the training process by the third node 113, but still take advantage of other worker data indirectly, e.g., by using the global model. Also with secure aggregation, data from the wireless device 130, which may be considered private may not be exchanged with the third node 113.

By determining in this Action 604, the first predictive model and the second predictive, the third node 113 may be enabled to accurately predict the behavior of the wireless device 130 during the future roaming period in terms of energy supply and use of data. The third node 113 may then be enabled to provide the predicted energy supply, and predicted use of data of the wireless device 130 during the roaming period, and thereby enable the first node 111 to optimize the selection of the second communications network 201 to be used by the wireless device 130 during roaming, based on the predicted behavior of the wireless device 130.

Similarly, by determining the third predictive model, the third node 113 may be enabled to accurately predict the location of the wireless device 130 during the future roaming period. The third node 113 may then be enabled to provide the predicted location of the wireless device 130 during the roaming period, and thereby enable the first node 111 to optimize the selection of the second communications network 201 to be used by the wireless device 130 during roaming, based on the predicted location of the wireless device 130.

### Action 605

In this Action 605, the third node 113 may determine, at least one of: i) which operators may be available and provide coverage to the predicted future location of the wireless device 130 during the roaming period, ii) which of the available operators providing coverage may have a capability to service the predicted use of data by the wireless device 130 during the roaming period, and iii) a respective efficiency of power usage of respective RAT used by the available operators providing coverage.

By determining in this Action 605, which operators may be available and provide coverage to the predicted future location of the wireless device 130 during the roaming period, which of the available operators providing coverage may have a capability to service the predicted use of data by the wireless device 130, and the respective efficiency of power usage of respective RAT used by the available operators, the third node 113 may be enabled to then provide this information to the first node 111, and thereby enable the first node 111 to optimize the selection of the second communications network 201 to be used by the wireless device 130 during roaming, based on the predicted behavior of the wireless device 130.

### Action 606

In this Action 606, the third node 113 may provide to the first node 111 operating in the communications system 100: i) the first indication indicating the energy supply by the wireless device 130 during the roaming period, as predicted with the first predictive model, and ii) the second indication indicating the use of data by the wireless device 130 during the roaming period as predicted with the second predictive model.

In some embodiments, the providing in this Action 606 may further comprise providing the third indication indicating the future location of the wireless device 130 as predicted during the roaming period.

By providing this information to the first node 111 in this Action 606, the third node 113 may thereby enable the first node 111 to optimize the selection of the second communications network 201 to be used by the wireless device 130 during roaming, based on the predicted behavior of the wireless device 130.

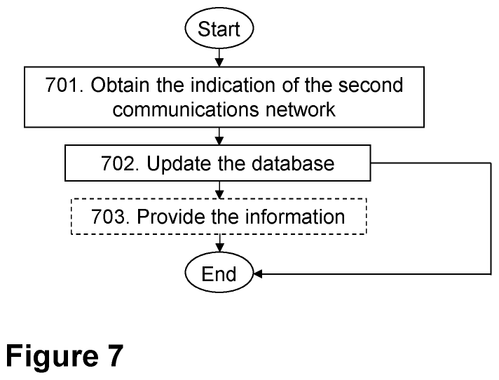

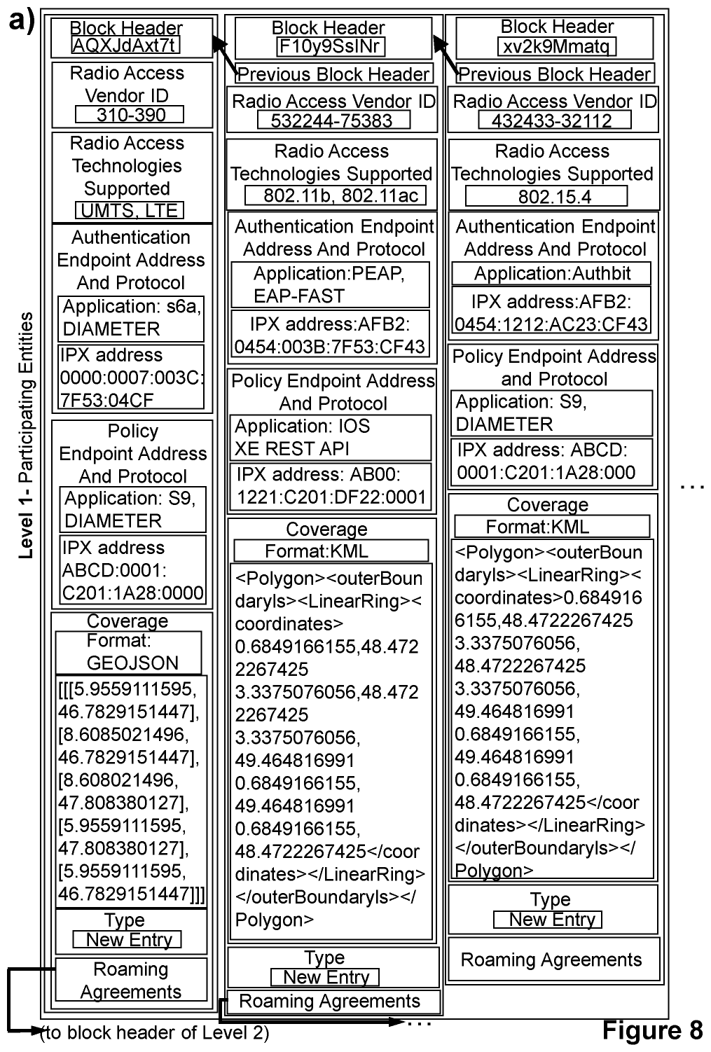

Embodiments of a method, performed by the second node 112, will now be described with reference to the flowchart depicted in FIG. 7. The method may be understood to be for handling roaming data. The second node 112 operates in the communications system 100.

Several embodiments are comprised herein. In some embodiments all the actions may be performed. In other embodiments, two or more actions may be performed. One or more embodiments may be combined, where applicable. All possible combinations are not described to simplify the description. It should be noted that the examples herein are not mutually exclusive. Components from one embodiment may be tacitly assumed to be present in another embodiment and it will be obvious to a person skilled in the art how those components may be used in the other exemplary embodiments. A non-limiting example of the method performed by the second node 112 is depicted in FIG. 7. In FIG. 7, actions which may be optional in some examples are depicted with dashed boxes. The detailed description of some of the following corresponds to the same references provided above, in relation to the actions described for the first node 111 and will thus not be repeated here to simplify the description. For example, the energy supply may be, for example, a level of battery of the wireless device 130.

### Action 701

In this Action 701, the second node 112 obtains, from the first node 111 operating in the communications system 100 the indication of the second communications network 201 determined to be used by the wireless device 130 for roaming communications during the roaming period.

The obtaining, e.g., receiving or acquiring in this Action 701 may be implemented e.g., via the first link 141.

By obtaining the indication in this Action 701, the second node 112 may be enabled to update the database 210 and thereby enable to optimize selection of other second communication networks for the wireless device 130 or other wireless devices, in other roaming periods.

### Action 702

In this Action 702, the second node 112 updates the database 120 with the obtained indication. The database 120 is a distributed, level database 120 comprising a plurality of layers. The plurality of layers comprises a first layer or Layer 1, a second layer or Layer 2 and a third layer or Layer 3. The first layer comprises first data of operators of respective communications networks, e.g., of the first communications network 101 and the entirety of the plurality of other communications networks 200 or a subset of the plurality of other communications networks 200, e.g., if a new network is comprised in the plurality of other communications networks 200, and the database 120 has no data regarding the new network yet. The first data comprises respective one or more RATs, used by the respective operators, and a respective coverage map of the respective operators, that is a map of radio coverage. The second layer is linked to the first layer. The second layer comprises second data of respective roaming agreements of the operators with the first communications network 101 the wireless device 130 is roaming from. The third layer is linked to the second layer. The third layer comprises roaming transactions of wireless devices in any of the respective communications networks. The wireless devices comprise the wireless device 130.

The database 120 may be at least one of layered, and immutable and synchronized.

To facilitate the description of the database 120, reference to FIG. 8 will be made. FIG. 8 is a schematic diagram illustrating a non-limiting example of the database 120 as a distributed ledger, in further detail. The distributed ledger comprises three layers: Layer 1 comprises. Panel a) of FIG. 8 depicts an overview of the three layers. To assist in the readability, panels b), c) and d) of FIG. 8 depict each of the three layers, respectively, magnified. The operators may have “write access” on the top two layers, the first layer and the second layer, and may have read access on the third. The first node 111 may have “write access” on the third layer and “read access” on the first layer and the second layer. It may be noted that while FIG. 8 illustrates the distributed ledger as a blockchain, other forms of distributed ledger may also be used. For example, a distributed, multi-layered hash table.

### First Layer

The first layer may comprise a record of the operators participating in the communications system 100. There may be three types of records, indicated by the type field: a) a new entry type, which may comprise information of a new operator joining the system, b) an update entry type, which may comprise updated information for an operator; it may comprise any of the entry types record, for example, updated coverage record, and c) a terminate entry type, which is not illustrated in FIG. 8, which may indicate that an operator is no longer part of the system. This type of entry may only comprise the unique radio access vendor id field, indicating the operator terminating its involvement.

The first type of record, the new entry type may comprise the following records.

First, the new entry type may comprise an identifier of the network operator, illustrated as Radio Access Vendor ID in FIG. 8. This may need to be unique to the entities participating in the database 120, e.g., in the blockchain. For example, the identifier may be a Home Network Identity (HNI) in case the mobile operator may be a 3GPP operator, and a company identifier, e.g., “företagsnummer” in Sweden, in case the operator may be a WiFi vendor or other type of vendor that may not have a distinguishing, standardized identifier as 3GPP operators may have.

Second, the new entry type may comprise a list of supported radio access technologies. This list may comprise different types of RATs that the operator may support. For example, in case of 3GPP, GSM, Universal Mobile Telecommunications Service (UMTS), LTE or 5G NR, may all be valid technologies. It may also be possible that in addition to the technologies, the operators may also list the bandwidth each technology may uses, as well as a spectrum range. For example: LTE(2.3-2.4) may indicate 4G/LTE technology with 100 MHz bandwidth starting from 2.3 GHz range. It may be noted that this may be considered optional and not illustrated in FIG. 8.

Third, the new entry type may comprise a list of supported authentication protocols and endpoint address for authentication. This may be required in order for a roaming agreement to be setup. FIG. 8 illustrates IPX network addresses, but different type of addresses may be added, depending on what type of network interconnection service the operators may use, e.g., it may be a GRX network, which may be understood to have a similar addressing scheme.

Fourth, the new entry type may comprise a list of supported policy configuration protocols and corresponding endpoint addresses. As discussed in the introductory section, these policies may relate to the QoS that may be required from the operator for the data traffic transmitted from/sent to the wireless device 130.

Fifth, the new entry type may comprise a coverage map, indicating the geographical location or locations which may be covered by the operator's mobile connectivity services. The coverage map may be described in the form of polygons, e.g., bounded boxes, in a popular format such as GEOJSON or Keyhole Markup Language (KML). Alternatively, information about coverage may not have to be explicitly stored in the block. Instead, a uniform resource identifier (URI) may be used to point to the coverage map to be retrieved. An example of such URI may be the Uniform Resource Locator (URL). For example, ftp://operator.com/res/coverage/map.kml may allow for the coverage map to be retrieved over the internet using File Transfer Protocol (FTP). FTP may have its own security layer, e.g., digest authentication. Other protocols and other protocols may be used that may offer better security and privacy, e.g., Secure Shell (SSH) FTP (SFTP) with end-to-end encryption and key-based authentication. It may be noted that this alternative approach is not illustrated in FIG. 8.

Sixth, in case where the operator may support multiple RATs, the new entry type may comprise a different authentication protocol and endpoint, policy protocol and endpoint and coverage map per RAT. This is not illustrated in FIG. 8, but it may be understood to be a possibility.

Seventh, the new entry type may comprise a type record, which may indicate the type of the block, e.g., update, terminate or in this case new entry.

Eighth, the new entry type may comprise a roaming agreements record, which may provide a link to the header of the first block of the second layer for a particular operator. It may be noted that only new entry type of blocks may have this roaming agreement record, as it may be not necessary to have them in other types.

### Second Layer

The middle layer may comprise roaming agreements for an operator. These roaming agreements blocks may comprise the identifiers of the operators the current operator may have agreements with. In addition, these blocks may comprise the validity period of the roaming contract and the billing plan. Finally, a transactions link towards layer 3, which may indicate the roaming transactions for the agreement. It may be noted that there may be revisions to a roaming agreement, in which a subsequent block may contain only information about the revisions as well as the identifier record identifying the roaming agreement. Examples of updates may be on the billing and/or pricing policy or the validity period.

### Third Layer

The third layer may comprise roaming transactions, indicating when a device of the current operator (“home operator”), such as the wireless device 130 may have used services from another operator in the roaming agreement. The transaction blocks may comprise information about the identity of the wireless device 130, e.g., IMSI, as well as the duration of service use, the volume of data and in case of a 3GPP visiting operator, the number of Short Messaging System (SMS) messages and number and duration of calls. Other details may include if a call may have been local or international, which is not illustrated in FIG. 8.

By updating the database 120 with the indication in this Action 702, the second node 112 may be enabled to enrich the database 210 and thereby enable to optimize selection of other second communication networks for the wireless device 130 or other wireless devices, in other roaming periods.

### Action 703

In this Action 703, the second node 112 may provide, to one of the first node 111, or another node 113, 115 operating in the communications system 100, information comprised in the database 120. The information may be provided to the third node 113 operating in the communications system 100. The information may comprise at least one of: a) all available operators to the wireless device 130, and b) the subset of the available operators the first operator of the first communications network 101 may have a respective roaming agreement with.

By providing the information to the first node 111 in this Action 703, the second node 112 may enable the first node 111 to optimize the selection of the second communications network 201 to be used by the wireless device 130 during roaming, based on the predicted behavior or the wireless device 130.

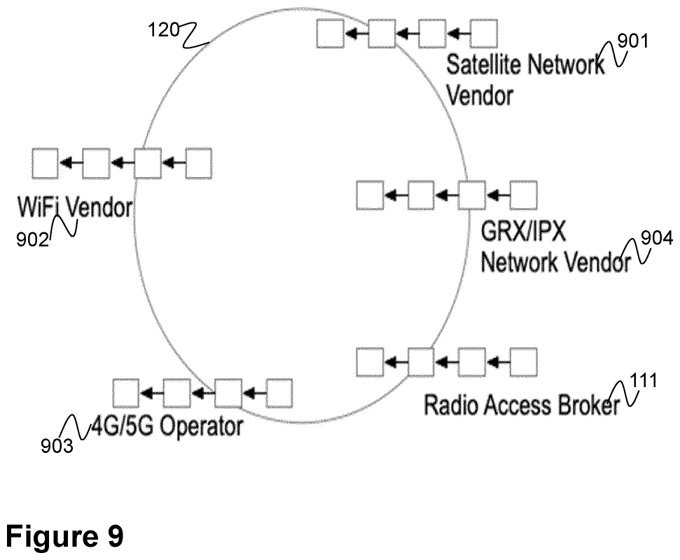

FIG. 9 depicts a schematic diagram illustrating some non-limiting examples of the types of entities that may perform the methods in the communications system 100, according to embodiments herein. First, embodiments herein may involve a set of radio access vendors, cellular or non-cellular, which may provide radio access services to devices such as the wireless device 130. The set of vendors may comprise satellite network vendors 901, WiFi vendors 902, 4G/5G Operators 903, and GRC/IPX network vendors 904. Second, embodiments herein may involve the database 120, which may be a multi-layer distributed ledger, an immutable, replicable, consensus-based database, as described above. Third, embodiments herein may involve the first node 111, a radio access broker, which may suggest the best radio access service for the wireless device 130, as described earlier.

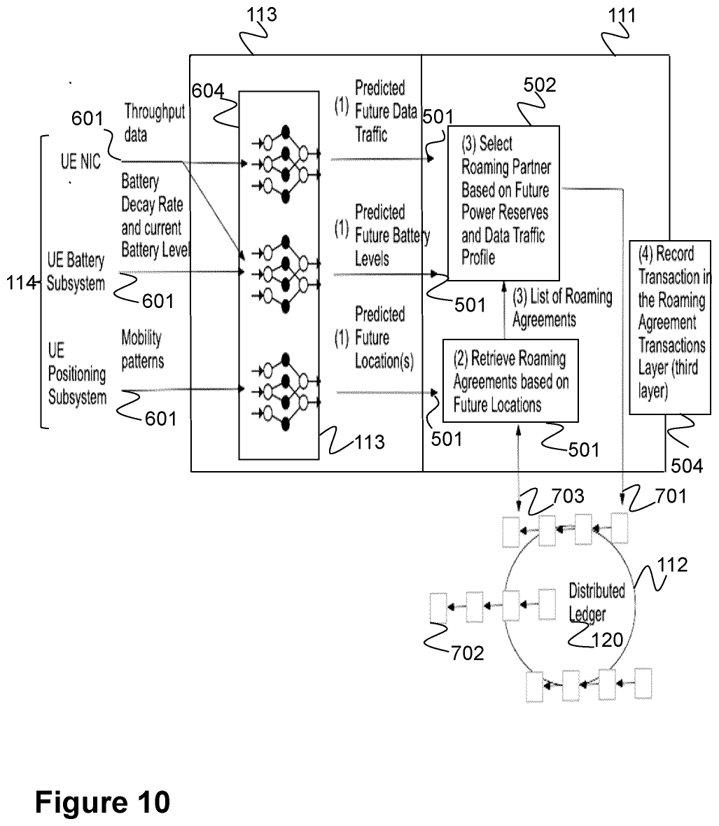

FIG. 10 is a schematic diagram illustrating a non-limiting example of the interaction between the first node 111, the third node 113 and the second node 112, according to the first group “A” of embodiments herein. In this example, the first node 111 and the third node 113 are co-localized. As depicted in the figure the third node 113 comprises three neural networks. The first neural network, depicted in the middle of the third node 113, obtains, according to Action 601, the first data indicating energy supply of the wireless device 130 as battery decay rate and current battery level, from a first fourth node 114, a battery subsystem in the wireless device 130, depicted as “UE Battery Subsystem”. The second neural network, depicted at the top of the third node 113, obtains, according to Action 601, the second data indicating use of data by the of the wireless device 130 as throughput data, from a second fourth node 114, a NIC in the wireless device 130, depicted as “UE NIC”. The third neural network, depicted at the bottom of the third node 113, obtains, according to Action 601, the third data indicating the future location of the wireless device 130, as mobility patterns, from a first fourth node 114, a NIC in the wireless device 130, depicted as “UE NIC”. The first node 111 then obtains, according to Action 501, the first indication indicating the future battery levels of the wireless device 130 during the roaming period, the second indication indicating the predicted future data traffic by the wireless device 130 during the roaming period, and the third indication indicating the predicted future location(s) of the wireless device 130 during the roaming period. The first node 111, in accordance with Action 501, retrieves, from the second node 112, a list of roaming agreements comprising the subset of the available operators the first operator of the first communications network 101 has a roaming agreement with, based on the future location(s) of the wireless device 130. The second node 112, in agreement with Action 703, provides this information from the database 120, a distributed ledger in this example. The first node 111 may then, according to Action 502, select a roaming partner for the wireless device 130, based on the future power reserves and the data traffic profiled of the wireless device 130. Lastly, the first node 111, in agreement with Action 504, records the transaction in the roaming agreement transactions layer, that is, the third layer. The second node 112 receives, in agreement with Action 701, receives the fourth indication, and updates the database 120 accordingly.

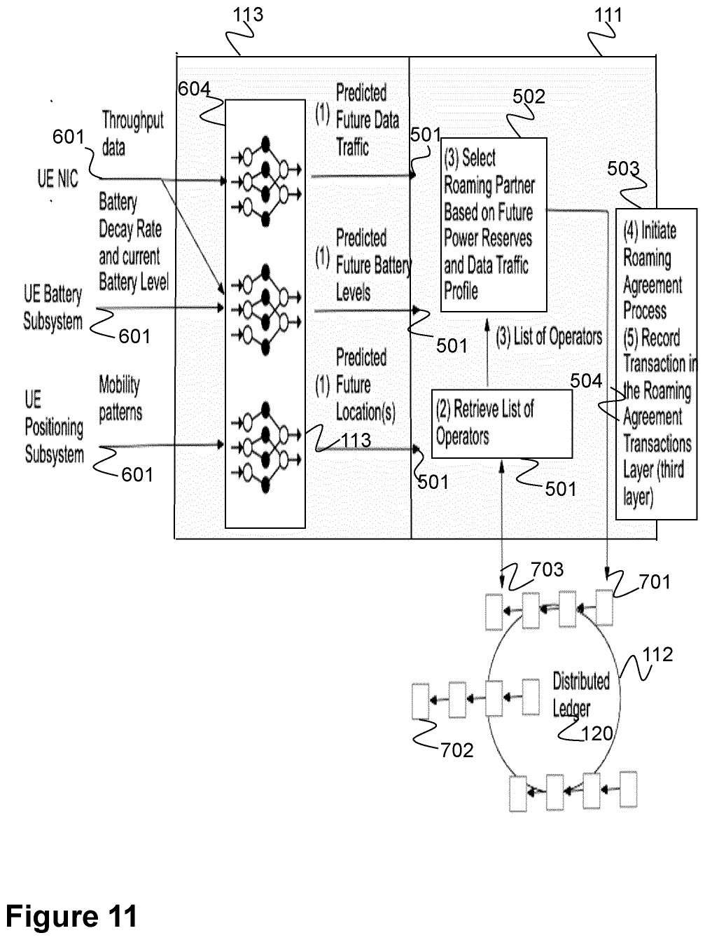

FIG. 11 is a schematic diagram illustrating another non-limiting example of the interaction between the first node 111, the third node 113 and the second node 112, according to the second group “B” of embodiments herein. Most of the steps are the same as those depicted in FIG. 10, and will therefore not be described again. In this group of examples, the first node 111, may choose a roaming agreement from all available operators, independently of whether or not an agreement already exists with the operators. Since in this example, the first node 111 selects an operator with whom an agreement does not exist, the first node 111, in agreement with Action 503, initiates a roaming agreement process, creating the roaming agreement dynamically.

FIG. 12 is a signalling diagram illustrating yet another non-limiting example of the interaction between the first node 111, the third node 113 and the second node 112, according to the first group “A” of embodiments alternative (alt), and to the second group “B” of embodiments herein. In this example, the one or more fourth nodes 114 comprise a NIC_API, a Power_API and a Positioning_API. The one or more fourth nodes 114 are co-localized with the first node 111 and the third node 113 in the wireless device 130. Also depicted in the Figure are the second node 112, the first operator or home operator, depicted as “homeO”, and the operator of the second communications network 201, depicted as “O2”. The depicted process is repeated, that is, loops, every 5 minutes, per day. Every 5 minutes, the third node 113, in agreement with Action 601, receives throughput data from the NIC, battery level data from the Power_API, and location data from the Positioning_API. The third node 113 then aggregates and stores the data to its buffer B. The third node 113 then, in agreement with Action 604, predicts the future throughput, battery level and mobility pattern of the wireless device 130. Next, the method may be performed according to two alternatives. According to the first group of examples “A”, the third node 113 may, according to Action 601, retrieve all operators home operator has agreements with as a list of operators “[list[operators]]”, and predicted mobility patterns. Next, the third node 113, in agreement with Action 605 and Action 501, provides the list of operators to the first node 111. In agreement with Action 606 and Action 501, the third node 113 also sends the predicted battery levels and mobility patterns to the first node 111. Next, the first node 111, in agreement with Action 502, selects the second communications network 201, e.g., operator2, from the list[operators] based on the predicted battery levels and the mobility patterns. Next, in agreement with Action 504, the first node 111 provides the fourth indication of the determined second communications network 201 as a new transaction to record to the second node 112, and enables that the wireless device 130 attaches to the second communications network 201. In the second group of examples “B”, the actions are the same, with the exception that here, the first node 111 selects from all available operators, independently of whether or not they may already have an agreement with the current operator of the wireless device 130. In this case, the second communications network 201 selected by the first node 111 does not have an agreement with the current operator. Hence, the first node 111 gets information on the home operator from the second node 112, that is, from the database 120 it manages, which is a distributed ledger in this example, and also gets information on the second operator of the selected second communications network 201 also from the second node 112, that is, form the database 120. As a consequence, the first operator and the second operator establish a roaming agreement using endpoints, and the wireless device 130 is enabled to attach to the second operator. Every 5 minutes, the third node 113 may, in agreement with Action 601, retrieve observations from the buffer B, and in agreement with Action 602, retrain its neural networks accordingly.

FIG. 13 is a schematic diagram illustrating a non-limiting example of the secure aggregation described above, which may be performed by the third node 113. The third node 113 is depicted as a server, particularly, a third party incorruptible entity. It aggregates model weights obtained, respectively, from different wireless devices, depicted as UEs, which are considered to be workers, that is the owners of the data. The third node 113 performs weight aggregation, for example, using federated averaging, and updates a global model accordingly.

FIG. 14 is a schematic diagram illustrating a non-limiting example of the adding secure aggregation information to the database 112, here a distributed ledger, according to embodiments herein. The database is multi-layered, as described in relation to FIG. 9. In embodiments wherein the secure aggregation may be performed, as described above, a new component to the “new entry” type of block in the first layer may be added, which may be called “Models”, which may point to a sub-layer of training data for a specific worker, that is, a specific wireless device such as the wireless device 130, which may be identified e.g., by its IMSI. Each training data block, besides the worker identity, may comprise the weights of the model as well as the epoch, that is, the iteration of training, as well as an identifier of the model indicating the type of model. The type of model may be understood to refer to whether the model may be the first predictive model, the second predictive model or the third predictive model, e.g., the battery decay rate predictor, the throughput predictor, or the mobility predictor. The database may also comprise a new block type in layer 1, which may be called global model, a block added by the incorruptible third-party authority. The block may comprise the epoch identifier, that is, an iteration number, as well as the weights of the global model as a result of secure aggregation. A model ID may indicate the type of model.

Embodiments herein may also comprise a method performed by the communications system 100, e.g., comprising the first node 111, the second node 112 and the third node 113, according to any of the above described embodiments.

Embodiments herein may also comprise a method performed by the communications system 100, e.g., comprising the first node 111, the second node 112 and the third node 113, according to any of the above described embodiments, and any of the above described optional embodiments.

Embodiments disclosed herein may be understood to provide the advantage of enabling to optimize roaming selection for the mobility of the wireless device 130 based on data a traffic profile and battery life of the wireless device 130.

As a further advantage, embodiments disclosed herein may be understood to maintain current QoS policies.

As a further advantage, embodiments disclosed herein may be understood to be able to be applied to existing mobile network infrastructure, without a need to change the standards.

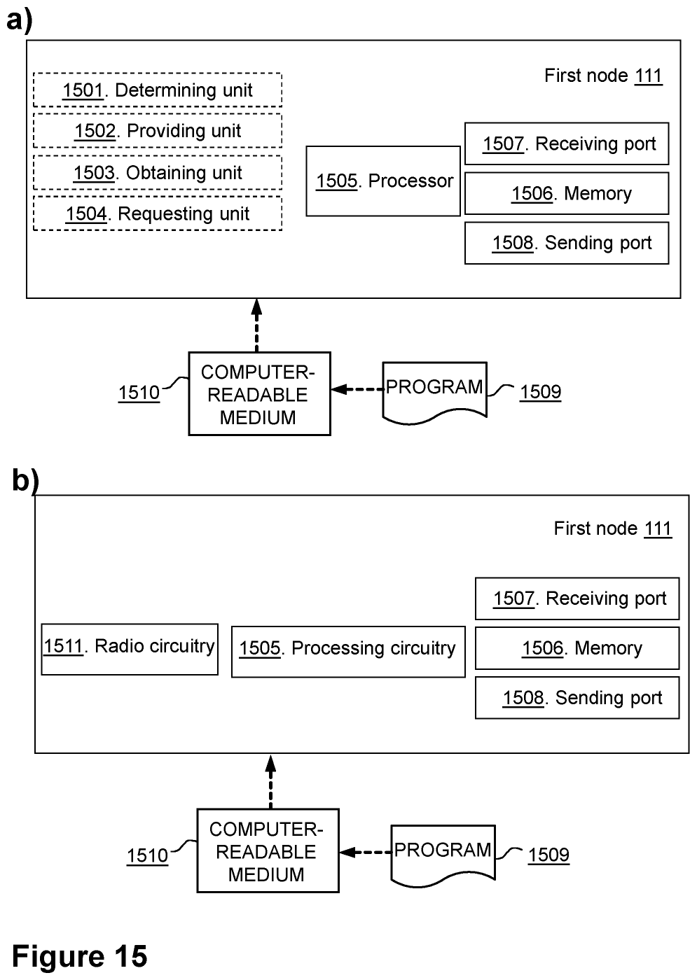

FIG. 15 depicts two different examples in panels a) and b), respectively, of the arrangement that the first node 111 may comprise. In some embodiments, the first node 111 may comprise the following arrangement depicted in FIG. 15a. The first node 111 may be understood to be for handling roaming of the wireless device 130 from the first communications network 101. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111 and will thus not be repeated here. For example, the energy supply may be configured to be, for example, a level of battery of the wireless device 130.

In FIG. 15, optional units are indicated with dashed boxes.

The first node 111 is configured to, e.g. by means of a determining unit 1501 within the first node 111 configured to, determine the second communications network 201 to be used by the wireless device 130 for roaming communications. The determining is configured to be based at least on: a) the predicted energy supply by the wireless device 130 during the roaming period, and b) the predicted use of data by the wireless device 130 during the roaming period.

The first node 111 is further configured to, e.g. by means of a providing unit 1502 within the first node 111 configured to, provide the indication of the second communications network 201 configured to be determined to at least one of: the second node 112 configured to operate in the communications system 100 and the wireless device 130.

In some embodiments, the determining may be further configured to be based on the predicted future location of the wireless device 130 during the roaming period.

In some embodiments, the second communications network 201 may be configured to be determined out of the plurality of other communication networks 200. The plurality of other communication networks 200 may be configured to be operated by one or more operators. The determining may be configured to comprise determining at least one of: i) which operators may be available and provide coverage to the predicted future location of the wireless device 130 during the roaming period; ii) which of the available operators configured to be providing coverage have the capability to service the predicted use of data by the wireless device 130 during the roaming period, and iii) the respective efficiency of power usage of respective RAT configured to be used by the available operators configured to be providing coverage.

The first node 111 may be configured to, e.g. by means of an obtaining unit 1503 within the first node 111 configured to, obtain, from the third node 113 configured to operate in the communications system 100, at least one of: the first indication, the second indication and the third indication. The first indication is configured to indicate the predicted energy supply by the wireless device 130 during the roaming period. The second indication is configured to indicate the predicted use of data by the wireless device 130 during the roaming period. The third indication is configured to indicate the predicted future location of the wireless device 130 during the roaming period. The provided indication may be configured to be the fourth indication.

In some embodiments, the obtaining may be configured to comprise obtaining the list of available operators. The list may be configured to comprise at least one of: a) all available operators at the predicted future location of the wireless device 130 during the roaming period, and b) the subset of the available operators the first operator of the first communications network 101 may be configured to have a roaming agreement with.

In some embodiments, the obtaining may be further configured to comprise obtaining the respective billing information from the available operators. The determining may be further configured to be based on the respective billing information configured to be obtained from the available operators.

In some embodiments, least one of the following may apply. The first node 111 is configured to be the radio access broker. The second node 112 may be configured to manage the database 120. The database 120 may be configured to be at least one of: layered and immutable and synchronized. The third node 113 may be configured to manage the one or more neural networks.

In some embodiments wherein the second communications network 201 configured to be determined may be configured to lack a current roaming agreement with the first communications network 101, the first node 111 may be configured to, e.g. by means of an requesting unit 1504 within the first node 111 configured to, request the respective roaming agreement from the second communications network 201 configured to be determined to provide roaming services to the wireless device 130 during the roaming period.

The embodiments herein in the first node 111 may be implemented through one or more processors, such as a processor 1505 in the first node 111 depicted in FIG. 15a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1506 comprising one or more memory units. The memory 1506 is arranged to be used to store obtained information, store data, configurations, schedulings, and applications etc. to perform the methods herein when being executed in the first node 111.

In some embodiments, the first node 111 may receive information from, e.g., the second node 112, the third node 113, the one or more fourth nodes 114, the another node 113, 115, the radio network node 140, the wireless device 130, or any other node, through a receiving port 1507. In some embodiments, the receiving port 1507 may be, for example, connected to one or more antennas in first node 111. In other embodiments, the first node 111 may receive information from another structure in the communications network 100 through the receiving port 1507. Since the receiving port 1507 may be in communication with the processor 1505, the receiving port 1507 may then send the received information to the processor 1505. The receiving port 1507 may also be configured to receive other information.

The processor 1505 in the first node 111 may be further configured to transmit or send information to e.g., the second node 112, the third node 113, the one or more fourth nodes 114, the another node 113, 115, the radio network node 140, the wireless device 130, any other node, and/or another structure in the communications network 100, through a sending port 1508, which may be in communication with the processor 1505, and the memory 1506.

Those skilled in the art will also appreciate that the units 1501-1504 described above may refer to a combination of analog and digital circuits, and/or one or more processors configured with software and/or firmware, e.g., stored in memory, that, when executed by the one or more processors such as the processor 1505, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1501-1504 described above may be implemented as one or more applications running on one or more processors such as the processor 1505.

Thus, the methods according to the embodiments described herein for the first node 111 may be respectively implemented by means of a computer program 1509 product, comprising instructions, i.e., software code portions, which, when executed on at least one processor 1505, cause the at least one processor 1505 to carry out the actions described herein, as performed by the first node 111. The computer program 1509 product may be stored on a computer-readable storage medium 1510. The computer-readable storage medium 1510, having stored thereon the computer program 1509, may comprise instructions which, when executed on at least one processor 1505, cause the at least one processor 1505 to carry out the actions described herein, as performed by the first node 111. In some embodiments, the computer-readable storage medium 1510 may be a non-transitory computer-readable storage medium, such as a CD ROM disc, or a memory stick. In other embodiments, the computer program 1509 product may be stored on a carrier containing the computer program 1509 just described, wherein the carrier is one of an electronic signal, optical signal, radio signal, or the computer-readable storage medium 1510, as described above.

The first node 111 may comprise a communication interface configured to facilitate communications between the first node 111 and other nodes or devices, e.g., the second node 112, the third node 113, the one or more fourth nodes 114, the another node 113, 115, the radio network node 140, the wireless device 130, any other node, and/or another structure in the communications network 100. The interface may, for example, include a transceiver configured to transmit and receive radio signals over an air interface in accordance with a suitable standard.

In other embodiments, the first node 111 may comprise the following arrangement depicted in FIG. 15b. The first node 111 may comprise a processing circuitry 1505, e.g., one or more processors such as the processor 1505, in the first node 111 and the memory 1506. The first node 111 may also comprise a radio circuitry 1511, which may comprise e.g., the receiving port 1507 and the sending port 1508. The processing circuitry 1505 may be configured to, or operable to, perform the method actions according to FIG. 5, and/or FIGS. 9-12, in a similar manner as that described in relation to FIG. 15a. The radio circuitry 1511 may be configured to set up and maintain at least a wireless connection with the second node 112, the third node 113, the one or more fourth nodes 114, the another node 113, 115, the radio network node 140, the wireless device 130, any other node, and/or another structure in the communications network 100. Circuitry may be understood herein as a hardware component.

Hence, embodiments herein also relate to the first node 111 operative to operate in the communications network 100. The first node 111 may comprise the processing circuitry 1505 and the memory 1506, said memory 1506 containing instructions executable by said processing circuitry 1505, whereby the first node 111 is further operative to perform the actions described herein in relation to the first node 111, e.g., in FIG. 5, and/or FIGS. 9-12.

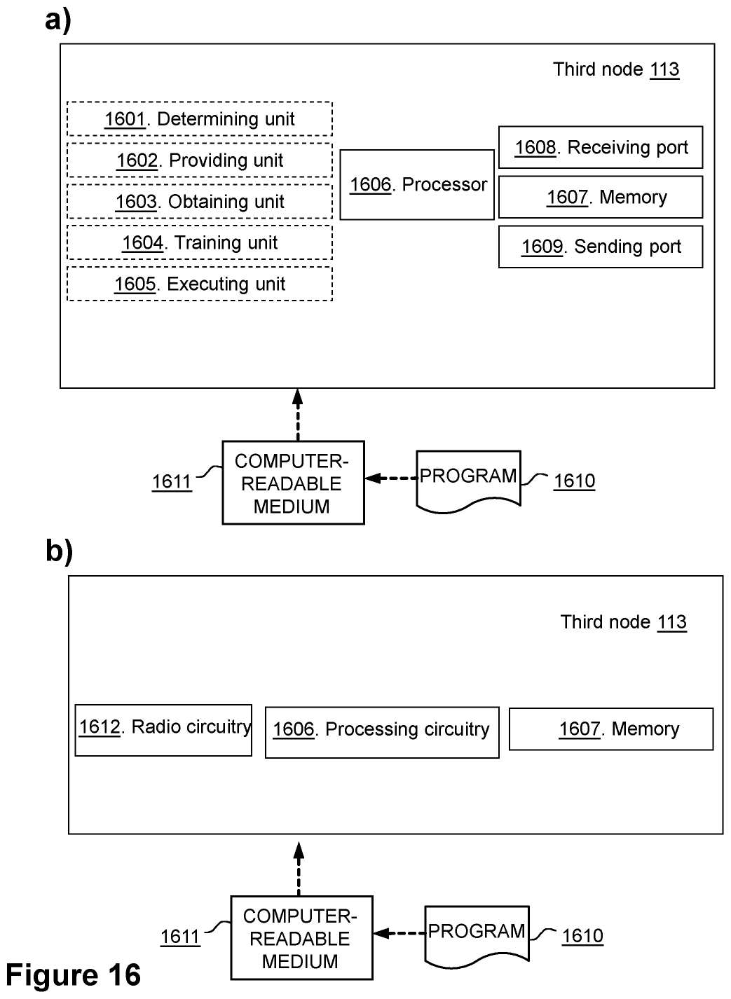

FIG. 16 depicts two different examples in panels a) and b), respectively, of the arrangement that the third node 113 may comprise. In some embodiments, the third node 113 may comprise the following arrangement depicted in FIG. 16a. The third node 113 may be understood to be for handling roaming of the wireless device 130 from the first communications network 101. The third node 113 is configured to operate in the communications system 100.

Several embodiments are comprised herein. Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the third node 113 and will thus not be repeated here. For example, the energy supply may be configured to be, for example, a level of battery of the wireless device 130.

In FIG. 16, optional units are indicated with dashed boxes.

The third node 113 is configured to, e.g. by means of a determining unit 1601 within the third node 113 configured to, determine, using machine learning: a) the first predictive model of energy supply by the wireless device 130 during the roaming period, and b) the second predictive model of use of data by the wireless device 130 during the roaming period.

The third node 113 is configured to, e.g. by means of a providing unit 1602 within the third node 113 configured to, provide to the first node 111 configured to operate in the communications system 100: the first indication and the second indication. The first indication is configured to indicate the energy supply by the wireless device 130 during the roaming period, as configured to be predicted with the first predictive model. The second indication is configured to indicate the use of data by the wireless device 130 during the roaming period as configured to be predicted with the second predictive model.

In some embodiments, the determining may be further configured to comprise determining the third predictive model of the future location of the wireless device 130 during the roaming period. The providing may be further configured to further comprise providing the third indication configured to indicate the future location of the wireless device 130 as configured to be predicted during the roaming period.

In some embodiments, wherein the communications system 100 may be configured to comprise the plurality of other communication networks 200, the third node 113 may be also configured to, e.g., by means of the determining unit 1601 within the third node 113 configured to, determine, at least one of the following options. According to a first option, which operators may be available and provide coverage to the predicted future location of the wireless device 130 during the roaming period. According to a second option, which of the available operators configured to be providing coverage may be configured to have the capability to service the predicted use of data by the wireless device 130 during the roaming period. According to a third option, the respective efficiency of power usage of respective RAT, configured to be used by the available operators configured to be providing coverage. The providing may be further configured to comprise providing the third indication configured to indicate the future location of the wireless device 130 as configured to be predicted during the roaming period.

The third node 113 may be configured to, e.g. by means of an obtaining unit 1603 within the third node 113 configured to, obtain, from the one or more fourth nodes 114 configured to operate in the communications system 100, at least one of: the first data, the second data an the third data. The first data may be configured to indicate the energy supply by the wireless device 130 during earlier roaming. The determining of the first predictive model may be configured to be based on the first data configured to be obtained. The second data may be configured to indicate the use of data by the wireless device 130 during the earlier roaming. The determining of the second predictive model may be configured to be based on the second data configured to be obtained. The third data may be configured to indicate the future location of the wireless device 130 during the earlier roaming period. The determining of the third predictive model may be configured to be based on the third data configured to be obtained.

In some embodiments, the obtaining may be further configured to comprise obtaining the list of available operators. The list may be further configured to comprise at least one of: a) all available operators at the future location of the wireless device 130 configured to be predicted during the roaming period, and b) the subset of the available operators the first operator of the first communications network 101 may be configured to have a respective roaming agreement with.

The third node 113 may be configured to, e.g. by means of a training unit 1604 within the third node 113 configured to, train at least one of: a) the first predictive model with the first set of the first data configured to be obtained, b) the second predictive model with the first set of the second data configured to be obtained, and c) the third predictive model with the first set of the third data configured to be obtained.

The third node 113 may be configured to, e.g. by means of an executing unit 1605 within the third node 113 configured to, execute at least one of: a) the first predictive model with the second set of the first data configured to be obtained, b) the second predictive model with the second set of the second data configured to be obtained, and c) the third predictive model with the second set of the third data configured to be obtained.

The determining of the first predictive model, the second predictive model and the third predictive model may be configured to be based on the one or more iterations of the training and the executing.

In some embodiments, at least one of the following may apply. The first node 111 may be configured to be the radio access broker. The third node 113 may be configured to manage the one or more neural networks. The one or more fourth nodes 114 may be configured to be comprised in the wireless device 130 and comprise: the NIC API, the battery subsystem and the UE positioning system.

The embodiments herein in the third node 113 may be implemented through one or more processors, such as a processor 1606 in the third node 113 depicted in FIG. 16a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1607 comprising one or more memory units. The memory 1607 is arranged to be used to store obtained information, store data, configurations, schedulings, and applications etc. to perform the methods herein when being executed in the third node 113.

In some embodiments, the third node 113 may receive information from, e.g., the first node 111, the second node 112, the one or more fourth nodes 114, the another node 113, 115, the radio network node 140, the wireless device 130, any other node, and/or another structure in the communications network 100, through a receiving port 1608. In some embodiments, the receiving port 1608 may be, for example, connected to one or more antennas in the third node 113. Since the receiving port 1608 may be in communication with the processor 1606, the receiving port 1608 may then send the received information to the processor 1606. The receiving port 1608 may also be configured to receive other information.

The processor 1606 in the third node 113 may be further configured to transmit or send information to e.g., the first node 111, the second node 112, the one or more fourth nodes 114, the another node 113, 115, the radio network node 140, the wireless device 130, any other node, and/or another structure in the communications network 100, through a sending port 1609, which may be in communication with the processor 1606, and the memory 1607.

Those skilled in the art will also appreciate that the units 1601-1605 described above may refer to a combination of analog and digital circuits, and/or one or more processors configured with software and/or firmware, e.g., stored in memory, that, when executed by the one or more processors such as the processor 1606, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1601-1605 described above may be implemented as one or more applications running on one or more processors such as the processor 1606.

Thus, the methods according to the embodiments described herein for the third node 113 may be respectively implemented by means of a computer program 1610 product, comprising instructions, i.e., software code portions, which, when executed on at least one processor 1606, cause the at least one processor 1606 to carry out the actions described herein, as performed by the third node 113. The computer program 1610 product may be stored on a computer-readable storage medium 1611. The computer-readable storage medium 1611, having stored thereon the computer program 1610, may comprise instructions which, when executed on at least one processor 1606, cause the at least one processor 1606 to carry out the actions described herein, as performed by the third node 113. In some embodiments, the computer-readable storage medium 1611 may be a non-transitory computer-readable storage medium, such as a CD ROM disc, or a memory stick. In other embodiments, the computer program 1610 product may be stored on a carrier containing the computer program 1610 just described, wherein the carrier is one of an electronic signal, optical signal, radio signal, or the computer-readable storage medium 1611, as described above.

The third node 113 may comprise a communication interface configured to facilitate communications between the third node 113 and other nodes or devices, e.g., the first node 111, the second node 112, the one or more fourth nodes 114, the another node 113, 115, the radio network node 140, the wireless device 130, any other node, and/or another structure in the communications network 100. The interface may, for example, include a transceiver configured to transmit and receive radio signals over an air interface in accordance with a suitable standard.

In other embodiments, the third node 113 may comprise the following arrangement depicted in FIG. 16b. The third node 113 may comprise a processing circuitry 1606, e.g., one or more processors such as the processor 1606, in the third node 113 and the memory 1607. The third node 113 may also comprise a radio circuitry 1612, which may comprise e.g., the receiving port 1608 and the sending port 1609. The processing circuitry 1606 may be configured to, or operable to, perform the method actions according to FIG. 6 and/or FIGS. 9-13, in a similar manner as that described in relation to FIG. 16a. The radio circuitry 1612 may be configured to set up and maintain at least a wireless connection with the first node 111, the second node 112, the one or more fourth nodes 114, the another node 113, 115, the radio network node 140, the wireless device 130, any other node, and/or another structure in the communications network 100. Circuitry may be understood herein as a hardware component.

Hence, embodiments herein also relate to the third node 113 operative to operate in the communications network 100. The third node 113 may comprise the processing circuitry 1606 and the memory 1607, said memory 1607 containing instructions executable by said processing circuitry 1606, whereby the third node 113 is further operative to perform the actions described herein in relation to the third node 113, e.g., in FIG. 6 and/or FIGS. 9-12.

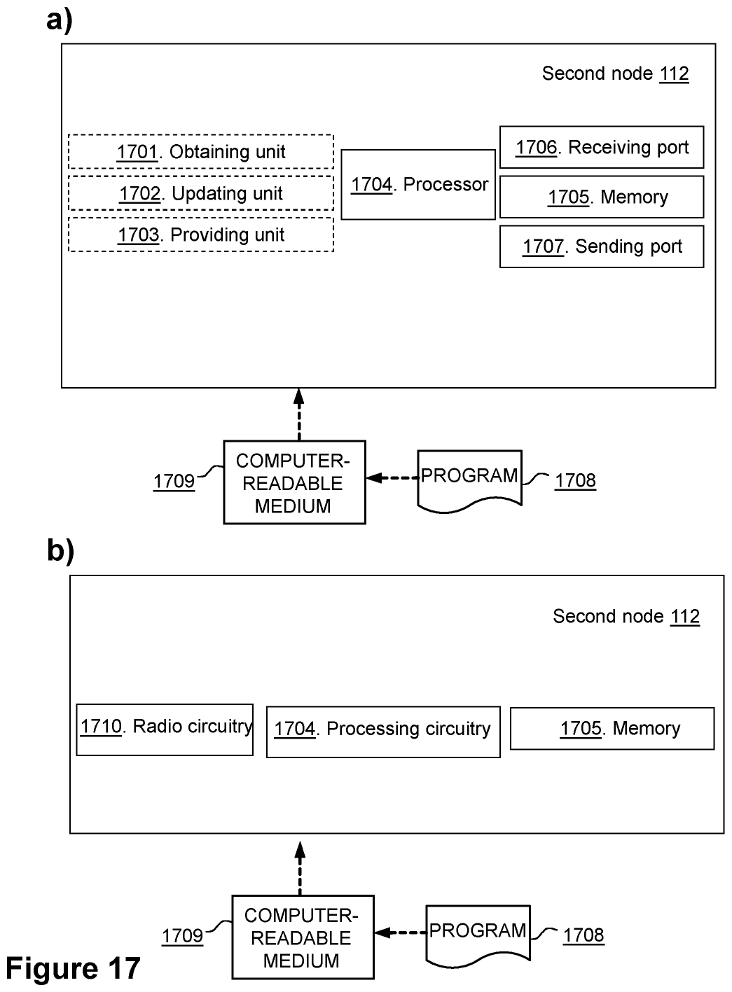

FIG. 17 depicts two different examples in panels a) and b), respectively, of the arrangement that the second node 112 may comprise. In some embodiments, the second node 112 may comprise the following arrangement depicted in FIG. 17a. The second node 112 may be understood to be for handling roaming data. The second node 112 is configured to operate in the communications system 100.

Several embodiments are comprised herein. Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112 and will thus not be repeated here. For example, the energy supply may be configured to be, for example, a level of battery of the wireless device 130.

In FIG. 17, optional units are indicated with dashed boxes.

The second node 112 is configured to, e.g. by means of an obtaining unit 1701 within the second node 112 configured to, obtain, from the first node 111 configured to operate in the communications system 100, the indication of the second communications network 201 configured to be determined to be used by the wireless device 130 for roaming communications during the roaming period.

The second node 112 is also configured to, e.g. by means of an updating unit 1702 within the second node 112 configured to, update the database 120 with the indication configured to be obtained. The database 120 is configured to be a distributed, level database 120 comprising the plurality of layers. The plurality of layers is configured to comprise: the first layer, the second layer and the third layer. The first layer is configured to comprise the first data of operators of respective communications networks. The first data is configured to comprise: i) the respective one or more RATs, configured to be used by the respective operators, and ii) the respective coverage map of the respective operators. The second layer is configured to be linked to the first layer. The second layer is configured to comprise the second data of the respective roaming agreements of the operators with the first communications network 101 the wireless device 130 is configured to be roaming from. The third layer is configured to be linked to the second layer. The third layer is configured to comprise the roaming transactions of the wireless devices in any of the respective communications networks. The wireless devices comprise the wireless device 130.

In some embodiments, the second communications network 201 may be configured to be determined out of the plurality of other communication networks 200.

The second node 112 may be configured to, e.g. by means of a providing unit 1703 within the second node 112 configured to, provide, to one of the first node 111, or another node 113, 115 configured to operate in the communications system 100, information configured to be comprised in the database 120.

In some embodiments, the information may be configured to be provided to the third node 113 configured to operate in the communications system 100. The information may be configured to comprise at least one of: a) all available operators to the wireless device 130, and b) the subset of the available operators the first operator of the first communications network 101 may be configured to have the respective roaming agreement with.

In some embodiments, least one of the following may apply. The first node 111 may be configured to be the radio access broker. The another node 113, 115 may be configured to be one of: i) the third node 113 configured to be managing the one or more neural networks, and ii) the node configured to be operating in one of the plurality of communication networks 200. The database 120 may be configured to be at least one of: layered and immutable and synchronized.

The embodiments herein in the second node 112 may be implemented through one or more processors, such as a processor 1704 in the second node 112 depicted in FIG. 17a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1705 comprising one or more memory units. The memory 1705 is arranged to be used to store obtained information, store data, configurations, schedulings, and applications etc. to perform the methods herein when being executed in the second node 112.

In some embodiments, the second node 112 may receive information from, e.g., the first node 111, the third node 113, the one or more fourth nodes 114, the another node 113, 115, the radio network node 140, the wireless device 130, any other node, and/or another structure in the communications network 100, through a receiving port 1706. In some embodiments, the receiving port 1706 may be, for example, connected to one or more antennas in the second node 112. Since the receiving port 1706 may be in communication with the processor 1704, the receiving port 1706 may then send the received information to the processor 1704. The receiving port 1706 may also be configured to receive other information.

The processor 1704 in the second node 112 may be further configured to transmit or send information to e.g., the first node 111, the third node 113, the one or more fourth nodes 114, the another node 113, 115, the radio network node 140, the wireless device 130, any other node, and/or another structure in the communications network 100, through a sending port 1707, which may be in communication with the processor 1704, and the memory 1705.

Those skilled in the art will also appreciate that the units 1701-1703 described above may refer to a combination of analog and digital circuits, and/or one or more processors configured with software and/or firmware, e.g., stored in memory, that, when executed by the one or more processors such as the processor 1704, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1701-1703 described above may be implemented as one or more applications running on one or more processors such as the processor 1704.

Thus, the methods according to the embodiments described herein for the second node 112 may be respectively implemented by means of a computer program 1708 product, comprising instructions, i.e., software code portions, which, when executed on at least one processor 1704, cause the at least one processor 1704 to carry out the actions described herein, as performed by the second node 112. The computer program 1708 product may be stored on a computer-readable storage medium 1709. The computer-readable storage medium 1709, having stored thereon the computer program 1708, may comprise instructions which, when executed on at least one processor 1704, cause the at least one processor 1704 to carry out the actions described herein, as performed by the second node 112. In some embodiments, the computer-readable storage medium 1709 may be a non-transitory computer-readable storage medium, such as a CD ROM disc, or a memory stick. In other embodiments, the computer program 1708 product may be stored on a carrier containing the computer program 1708 just described, wherein the carrier is one of an electronic signal, optical signal, radio signal, or the computer-readable storage medium 1709, as described above.

The second node 112 may comprise a communication interface configured to facilitate communications between the second node 112 and other nodes or devices, e.g., the first node 111, the third node 113, the one or more fourth nodes 114, the another node 113, 115, the radio network node 140, the wireless device 130, any other node, and/or another structure in the communications network 100. The interface may, for example, include a transceiver configured to transmit and receive radio signals over an air interface in accordance with a suitable standard.

In other embodiments, the second node 112 may comprise the following arrangement depicted in FIG. 17b. The second node 112 may comprise a processing circuitry 1704, e.g., one or more processors such as the processor 1704, in the second node 112 and the memory 1705. The second node 112 may also comprise a radio circuitry 1610, which may comprise e.g., the receiving port 1706 and the sending port 1707. The processing circuitry 1704 may be configured to, or operable to, perform the method actions according to FIG. 7, FIGS. 8-11 and/or FIG. 14, in a similar manner as that described in relation to FIG. 17a. The radio circuitry 1610 may be configured to set up and maintain at least a wireless connection with the first node 111, the third node 113, the one or more fourth nodes 114, the another node 113, 115, the radio network node 140, the wireless device 130, any other node, and/or another structure in the communications network 100. Circuitry may be understood herein as a hardware component.

Hence, embodiments herein also relate to the second node 112 operative to operate in the communications network 100. The second node 112 may comprise the processing circuitry 1704 and the memory 1705, said memory 1705 containing instructions executable by said processing circuitry 1704, whereby the second node 112 is further operative to perform the actions described herein in relation to the second node 112, e.g., in FIGS. 8-11 and/or FIG. 14.

Embodiments herein may also comprise the communications system 100, e.g., comprising the first node 111, the second node 112 and the third node 113, according to any of the above described embodiments.

Embodiments herein may also comprise the communications system 100, e.g., comprising the first node 111, the second node 112 and the third node 113, according to any of the above described embodiments, and any of the above described optional embodiments. As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term. When using the word “comprise” or “comprising” it shall be interpreted as non-limiting, i.e. meaning “consist at least of”.

A processor may be understood herein as a hardware component.

The embodiments herein are not limited to the above described preferred embodiments. Various alternatives, modifications and equivalents may be used. Therefore, the above embodiments should not be taken as limiting the scope of the invention.

### REFERENCES

1. 3rd Generation Partnership Project; Technical Specification Group Services and System Aspects; General Packet Radio Service (GPRS) enhancements for Evolved Universal Terrestrial Radio Access Network (E-UTRAN) access (Release 16)
2. H. Zhang, X. Chu, W. Guo and S. Wang, “Coexistence of Wi-Fi and heterogeneous small cell networks sharing unlicensed spectrum,” in IEEE Communications Magazine, vol. 53, no. 3, pp. 158-164, March 2015, doi: 10.1109/MCOM.2015.7060498.

1. A method performed by a first node, the method being for handling roaming of a wireless device from a first communications network, the first node operating in a communications system, the method comprising:
determining a second communications network to be used by the wireless device for roaming communications, the determining being based on one or more of:
a) a predicted energy supply by the wireless device during a roaming period, and
b) a predicted use of data by the wireless device during the roaming period, and
providing an indication of the determined second communications network to at least one of: a second node operating in the communications system and the wireless device.

2. The method according to claim 1, wherein the determining is further based on:
c) a predicted future location of the wireless device during the roaming period.

3. The method according to claim 1, wherein the second communications network is determined out of a plurality of other communication networks, the plurality of other communication networks being operated by one or more operators, and wherein the determining comprises determining at least one of:
i. which operators are available and provide coverage to the predicted future location of the wireless device during the roaming period,
ii. which of the available operators providing coverage have a capability to service the predicted use of data by the wireless device during the roaming period, and
iii. a respective efficiency of power usage of respective Radio Access Technology, RAT, used by the available operators providing coverage.

4. The method according to claim 3, further comprising:
obtaining, from a third node operating in the communications system, at least one of:
a) a first indication indicating the predicted energy supply by the wireless device during the roaming period,
b) a second indication indicating the predicted use of data by the wireless device during the roaming period, and
c) a third indication indicating the predicted future location of the wireless device during the roaming period, and
wherein the provided indication is a fourth indication.

5. The method according to claim 4, wherein the obtaining further comprises obtaining a list of available operators wherein the list comprises at least one of:
a. all available operators at the predicted future location of the wireless device during the roaming period, and
b. a subset of the available operators a first operator of the first communications network has a roaming agreement with.

6. The method according to claim 5, wherein the obtaining further comprises obtaining respective billing information from the available operators, and wherein the determining is further based on the obtained respective billing information from the available operators.

7. The method according to claim 4, wherein at least one of:
a. the first node is a radio access broker,
b. the second node manages a database, the database being at least one of: i) layered and ii) immutable and synchronized, and
c. the third node manages one or more neural networks.

8. The method according to claim 1, wherein the determined second communications network lacks a current roaming agreement with the first communications network, and wherein the method further comprises:
requesting a respective roaming agreement from the determined second communications network to provide roaming services to the wireless device during the roaming period.

9. A method performed by a third node, the method being for handling roaming of a wireless device from a first communications network, the third node operating in a communications system, the method comprising:
determining, using machine learning:
a) a first predictive model of energy supply by the wireless device during a roaming period, and
b) a second predictive model of use of data by the wireless device during the roaming period, and
providing to a first node operating in the communications system:
i. a first indication indicating an energy supply by the wireless device during the roaming period, as predicted with the first predictive model, and
ii. a second indication indicating a use of data by the wireless device during the roaming period as predicted with the second predictive model.

10. The method according to claim 9, wherein the determining further comprises determining:
c) a third predictive model of a future location of the wireless device during the roaming period,
and wherein the providing further comprises providing a third indication indicating the future location of the wireless device as predicted during the roaming period.

11. The method according to claim 10, wherein the communications system comprises a plurality of other communication networks, and wherein the method further comprises:
determining, at least one of:
i. which operators are available and provide coverage to the predicted future location of the wireless device during the roaming period,
ii. which of the available operators providing coverage have a capability to service the predicted use of data by the wireless device during the roaming period, and
iii. a respective efficiency of power usage of respective Radio Access Technology, RAT, used by the available operators providing coverage,
and wherein the providing further comprises providing a third indication indicating the future location of the wireless device as predicted during the roaming period.

12. The method according to claim 10, further comprising:
obtaining, from one or more fourth nodes operating in the communications system, at least one of:
a) first data indicating energy supply by the wireless device during earlier roaming, wherein the determining of the first predictive model is based on the obtained first data,
b) second data indicating use of data by the wireless device during the earlier roaming, wherein the determining of the second predictive model is based on the obtained second data, and
c) third data indicating a future location of the wireless device during the earlier roaming period, wherein the determining of the third predictive model is based on the obtained third data.

13. The method according to claim 12 wherein the obtaining further comprises obtaining a list of available operators wherein the list comprises at least one of:
a. all available operators at the predicted future location of the wireless device during the roaming period, and
b. a subset of the available operators a first operator of the first communications network has a respective roaming agreement with.

14. The method according to claim 12, further comprising:
training at least one of:
a) the first predictive model with a first set of the obtained first data,
b) the second predictive model with a first set of the obtained second data, and
c) the third predictive model with a first set of the obtained third data, and
executing at least one of:
d) the first predictive model with a second set of the obtained first data,
e) the second predictive model with a second set of the obtained second data, and
f) the third predictive model with a second set of the obtained third data,
and wherein the determining is based on one or more iterations of the training and the executing.

15. The method according to claim 12, wherein at least one of:
a. the first node is a radio access broker,
b. the third node manages one or more neural networks, and
c. the one or more fourth nodes are comprised in the wireless device and comprise: a Network Interface Card, NIC, Application Program Interface, API, a battery subsystem and a UE positioning system.

16. A method performed by a second node, the method being for handling roaming data, the second node operating in a communications system:
obtaining, from a first node operating in the communications system an indication of a second communications network determined to be used by the wireless device for roaming communications during a roaming period, and
updating a database with the obtained indication, the database being a distributed, level database comprising a plurality of layers, wherein the plurality of layers comprises:
a) a first layer comprising first data of operators of respective communications networks, the first data comprising:
i. respective one or more Radio Access Technologies, RATs, used by the respective operators, and
ii. a respective coverage map of the respective operators,
b) a second layer linked to the first layer, the second layer comprising second data of respective roaming agreements of the operators with a first communications network the wireless device is roaming from, and
c) a third layer linked to the second layer, the third layer comprising roaming transactions of wireless devices in any of the respective communications networks, the wireless devices comprising the wireless device.

17. (canceled)

18. The method according to claim 16, further comprising:
providing, to one of the first node, or another node operating in the communications system, information comprised in the database.

19. The method according to claim 18, wherein the information is provided to a third node operating in the communications system, and wherein the information comprises at least one of:
a. all available operators to the wireless device, and
b. a subset of the available operators a first operator of the first communications network has a respective roaming agreement with.

20. The method according to claim 18, wherein at least one of:
a. the first node is a radio access broker,
b. the another node is one of: i) a third node managing one or more neural networks, and ii) a node operating in one of the plurality of communication networks, and
c. the database is at least one of: i) layered and ii) immutable and synchronized.

21-22. (canceled)

23. A first node, for handling roaming of a wireless device from a first communications network, the first node being configured to operate in a communications system, the first node being further configured to:
determine a second communications network to be used by the wireless device for roaming communications, the determining being configured to be based at least on:
a) a predicted energy supply by the wireless device during a roaming period, and
b) a predicted use of data by the wireless device during the roaming period, and
provide an indication of the second communications network configured to be determined to at least one of: a second node configured to operate in the communications system and the wireless device.

24-45. (canceled)
